(19) United States
(12) Patent Application Publication
(10) Pub. No.: US 2026/0065516 A1
(43) Pub. Date: Mar. 5, 2026

(54) PLUG-AND-PLAY DIFFUSION DISTILLATION

(71) Applicant: ADOBE INC., SAN JOSE, CA (US)

(72) Inventors: Yi-Ting Hsiao, Sunnyvale, CA (US); Siavash Khodadadeh, Mountain View, CA (US); Kevin Duarte, San Jose, CA (US); Wei-An Lin, Seattle, WA (US); Hui Qu, Santa Clara, CA (US); Ratheesh Kalarot, San Jose, CA (US)

(21) Appl. No.: 18/816,827

(22) Filed: Aug. 27, 2024

(51) Int. Cl. G06T 11/00; G06F 40/40

(52) U.S. Cl. CPC G06T 11/00; G06F 40/40

(57) ABSTRACT

A method, apparatus, non-transitory computer readable medium, and system for image processing include obtaining a text prompt and a guidance parameter, where the text prompt describes an image element and the guidance parameter indicates a level of guidance intensity for the text prompt, computing guidance features based on the text prompt and the guidance parameter, and generating a synthetic image that depicts the image element based on the text prompt and the guidance features.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on an input such as a text prompt, an image, or a style.

In some cases, distillation is a technique used to transfer knowledge from a large, complex image generation model (e.g., a teacher model) to a smaller, lightweight image generation model (e.g., a student model) to simplify the generative process. In some aspects, the student model is trained to mimic the behavior and output of the teacher model. In some cases, the knowledge is transferred to the student model by initializing the parameters of the student model using the parameters of the teacher model.

### SUMMARY

Aspects of the present disclosure provide a method and system for text-to-image generation. In one aspect, the system receives a text prompt describing an image element and a guidance parameter indicating a level of guidance intensity for the text prompt to generate a synthetic image depicting the image element. According to some aspects, the system includes a guidance model trained to generate layer-specific latent feature maps that guides the image generation process based on the text prompt and the guidance parameter. In one aspect, each of the layer-specific latent feature maps is added to a feature of a corresponding decoding layer of the image generation model to obtain combined features. In one aspect, the image generation model is configured to generate a synthetic image based on the text prompt and the combined features to generate the synthetic image.

A method, apparatus, non-transitory computer readable medium, and system for image processing include obtaining a training set including a training prompt, a training image, and a guidance parameter, wherein the training prompt describes an image element, the training image depicts the image element, and the guidance parameter indicates a level of guidance intensity for the training prompt; and training, using the training set, an image generation model to generate a synthetic image that depicts the image element based on the guidance parameter, the training comprising training a guidance model of the image generation model to computes guidance features based on the guidance parameter and training a diffusion model of the image generation model to generate the synthetic image based on the training prompt, the training image, and the guidance features.

A method, apparatus, non-transitory computer readable medium, and system for image processing include obtaining a training set including a training prompt, a training image, and a guidance parameter, where the training prompt describes an image element, the training image depicts the image element, and the guidance parameter indicates a level of guidance intensity for the training prompt and training, using the training set, an image generation model to generate a synthetic image that depicts the image element based on the guidance parameter, where the image generation model includes a guidance model that computes guidance features based on the guidance parameter and a diffusion model that generates the synthetic image based on the guidance features.

An apparatus and system for image processing include at least one processor, at least one memory storing instructions executable by the at least one processor, and an image generation model comprising parameters stored in the at least one memory, where the image generation model is trained to generate a synthetic image that depicts an image element based on a text prompt, and where the image generation model comprises a guidance model trained to compute guidance features based on the text prompt and a guidance parameter that indicates a level of guidance intensity for the text prompt.

### BRIEF DESCRIPTION OF THE DRAWINGS

FIG. 1 shows an example of an image processing system according to aspects of the present disclosure.

FIG. 2 shows an example of a method for text conditional image generation according to aspects of the present disclosure.

FIG. 3 shows an example of text-to-image generation according to aspects of the present disclosure.

FIG. 4 shows an example of text-to-image generation using trained diffusion models according to aspects of the present disclosure.

FIG. 5 shows an example of a method for generating a synthetic image based on guidance features according to aspects of the present disclosure.

FIG. 6 shows an example of an image processing apparatus according to aspects of the present disclosure.

FIG. 7 shows an example of a machine learning system according to aspects of the present disclosure.

FIG. 8 shows an example of a full guidance model according to aspects of the present disclosure.

FIG. 9 shows an example of a tiny guidance model according to aspects of the present disclosure.

FIG. 10 shows an example of an image generation model according to aspects of the present disclosure.

FIG. 11 shows an example of a U-Net architecture according to aspects of the present disclosure.

FIG. 12 shows an example of a diffusion process according to aspects of the present disclosure.

FIG. 13 shows an example of a method for training an image generation model according to aspects of the present disclosure.

FIG. 14 shows an example of training a student image generation model according to aspects of the present disclosure.

FIG. 15 shows an example of an algorithm for classifier-free guidance (CFG) distillation according to aspects of the present disclosure.

FIG. 16 shows an example of a flow diagram depicting an algorithm as a step-by-step procedure in an example implementation of operations performable for training a machine learning model according to aspects of the present disclosure.

FIG. 17 shows an example of a method for training a diffusion model according to aspects of the present disclosure.

FIG. 18 shows an example of a computing device according to aspects of the present disclosure.

### DETAILED DESCRIPTION

The following relates to text-to-image generation using a student generative machine learning model. In the field of distillation process, knowledge is transferred from a large, complex image generation model (e.g., a teacher model) to a smaller, lightweight image generation model (e.g., a student model) to simplify the generative process. In some cases, for example, the student model is trained to mimic the behavior and output of the teacher model. In some aspects, the student model has substantially the same system architecture as the teacher model.

Embodiments of the disclosure relate to an image generation system that efficiently generates images having substantially the same image quality as the outputs of a teacher generative model. In one aspect, the system includes a guidance model trained to generate guidance features that includes information of visual features to be generated in the synthetic image. In some aspect, the guidance features combined with the image features of an image generation model to guide the image generation process that aligns with the guidance intensity indicated by the guidance parameter.

Classifier-free guidance (CFG) is a technique used in image generation, particularly in the context of diffusion models. For example, CFG enhances the image quality and fidelity of the generated images by utilizing the internal mechanism of the model for guidance and independent of external classifiers. For example, during the sampling process, at each diffusion timestep, the model is run twice (e.g., one for the conditional forward pass and another for the unconditional forward pass) to generate an enhanced output image. Then, the outputs of the two passes are combined at each diffusion timestep. However, the sampling speed of the models remains a challenge (e.g., long processing time). In some cases, the iterative process of reducing noise during the reverse diffusion process requires a large number of iterations, thus reducing the efficiency of the model.

A technique to address the aforementioned issue is using distillation technique. For example, a student model is trained to approximate the output of the teacher model from less denoising steps. In some cases, the weights of the student model are initialized based on the weights of the teacher model. However, distillation techniques still pose several issues. For example, student models may include a comparable number of parameters as the teacher model, and thus distillation technique may increase training cost. In some cases, diffusion models can be fine-tuned to generate specific content based on a specific dataset. However, distillation technique might not retain the fine-tuned adaptations. In some cases, the distilled student model may be re-trained for each new domain of interest, which further increases the need of training resources.

Accordingly, embodiments of the disclosure improve on conventional image generation models by generating synthetic images more efficiently while maintaining the image quality. This is achieved using a system that includes a guidance model that is trained to generate guidance features based on the text prompt and the guidance parameter. In one aspect, the output of the guidance model has the same effect as the internal mechanism of the model used for guidance in the CFG. In one aspect, the guidance model has fewer parameters than the diffusion model. Thus, the system can efficiently generate a synthetic image having enhanced image quality without running the diffusion model twice.

In one aspect, the guidance model is trained to generate guidance features based on the text prompt and the guidance parameter. In some cases, the guidance parameter controls how much weight is given to different types of guidance signals, such as textual description that steers the image generation process. In some cases, the guidance features are used to guide the image generation process of the image generation model. By using the guidance feature, the image generation model is able to efficiently generate a synthetic image that aligns with the input conditions (e.g., the text prompt and the guidance parameter) without having to run the diffusion model of the image generation model twice.

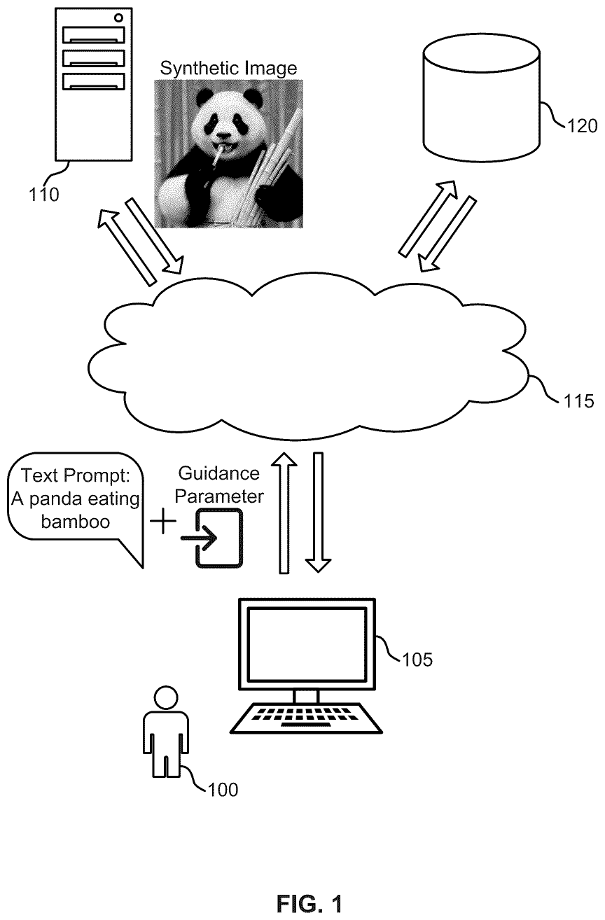

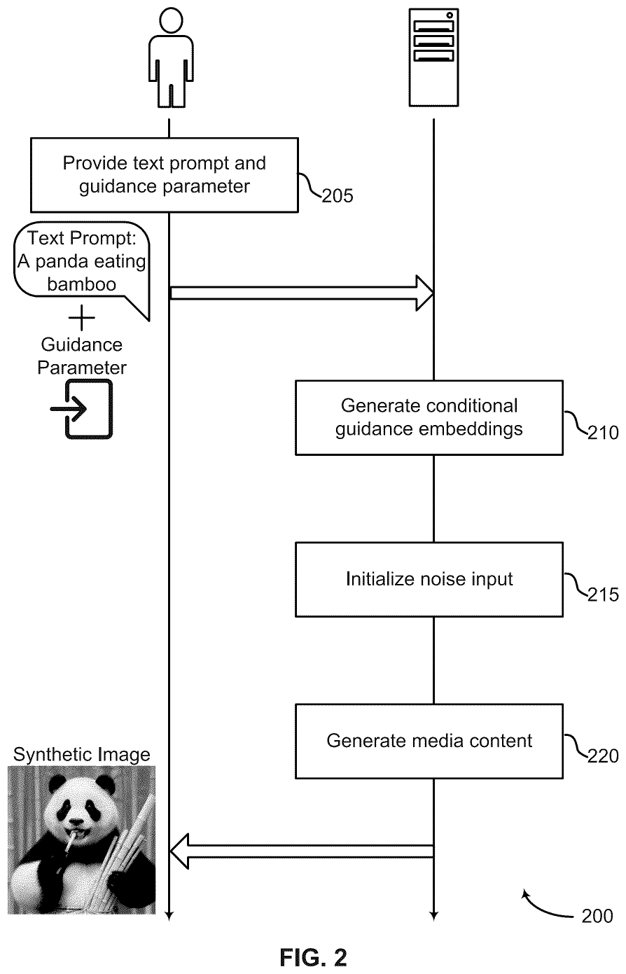

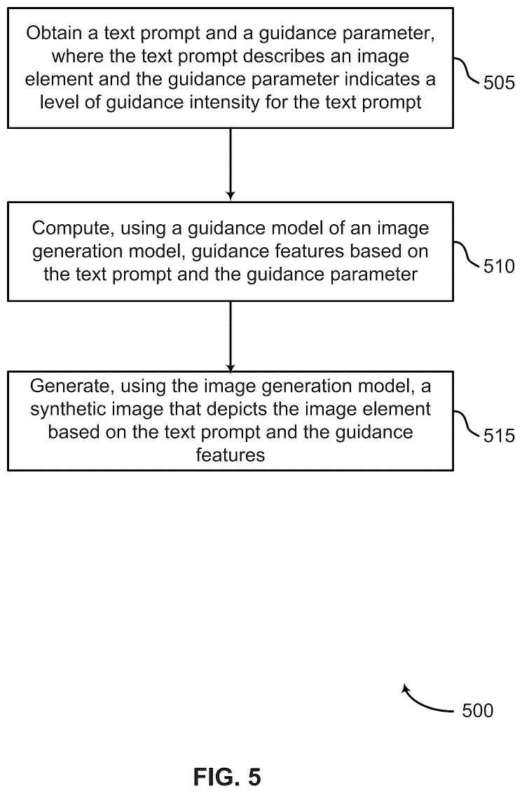

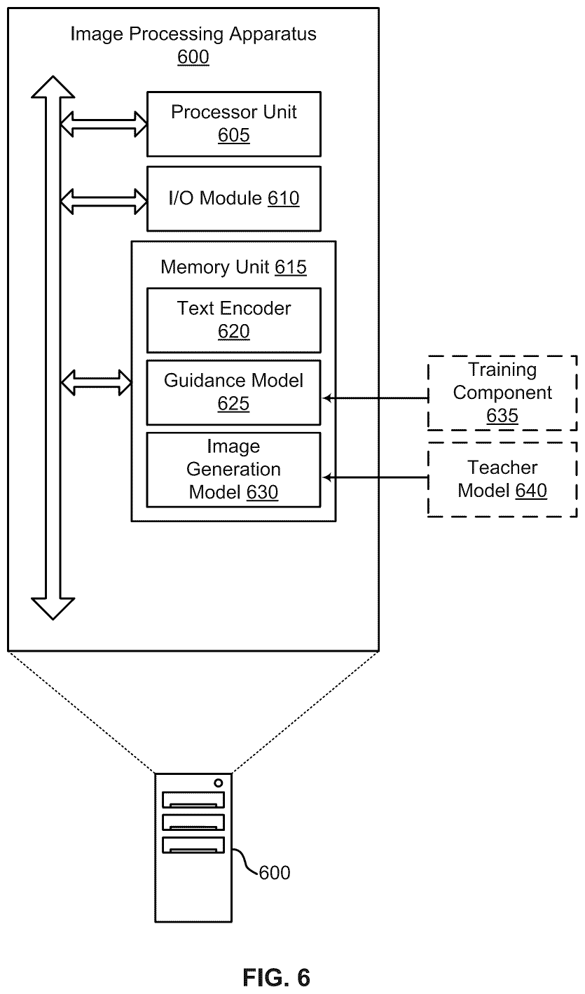

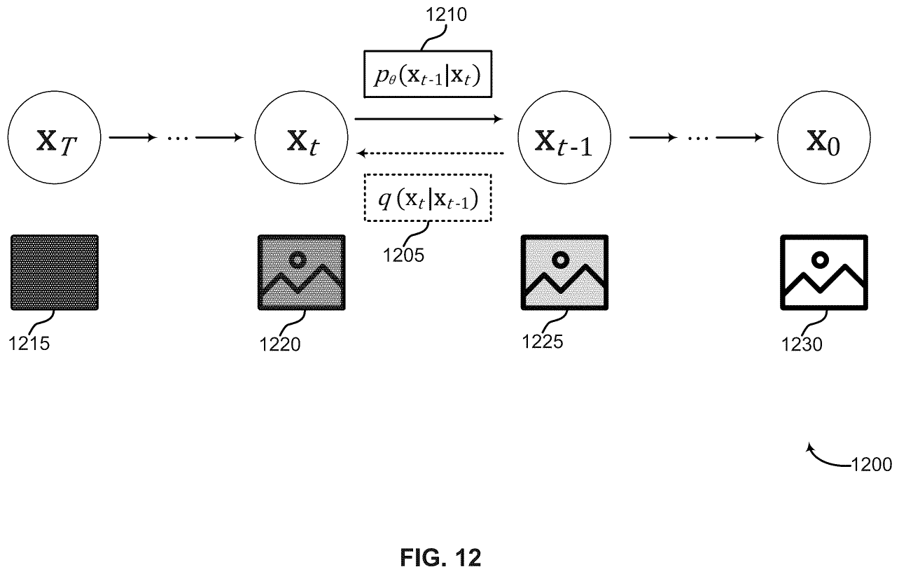

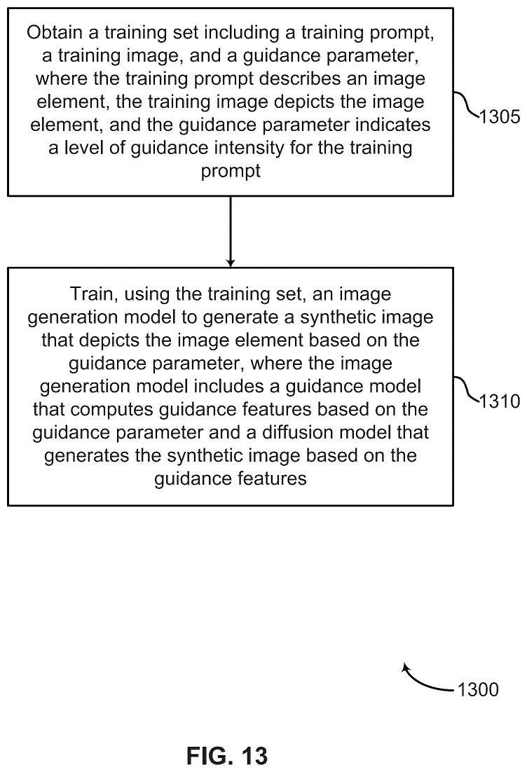

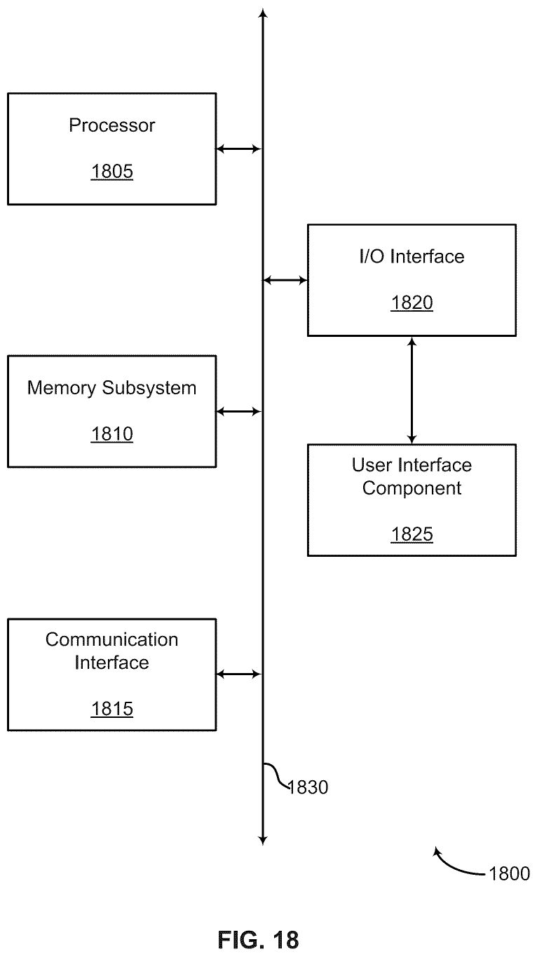

An example system of the inventive concept in image processing is provided with reference to FIGS. 1 and 18. An example application of the inventive concept in image processing is provided with reference to FIGS. 2-4. Details regarding the architecture of an image processing apparatus are provided with reference to FIGS. 6-11. An example of a process for image processing is provided with reference to FIGS. 5 and 12. A description of an example training process is provided with reference to FIG. 13-17.

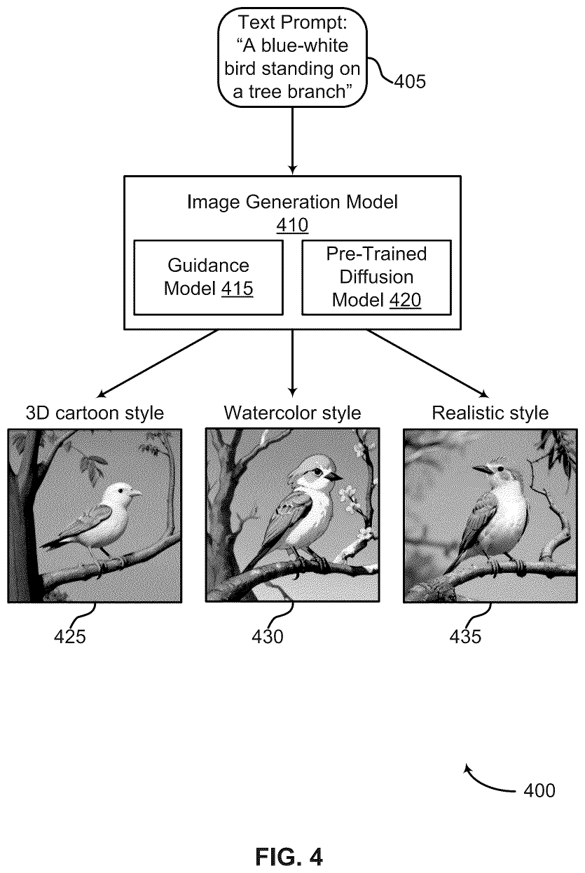

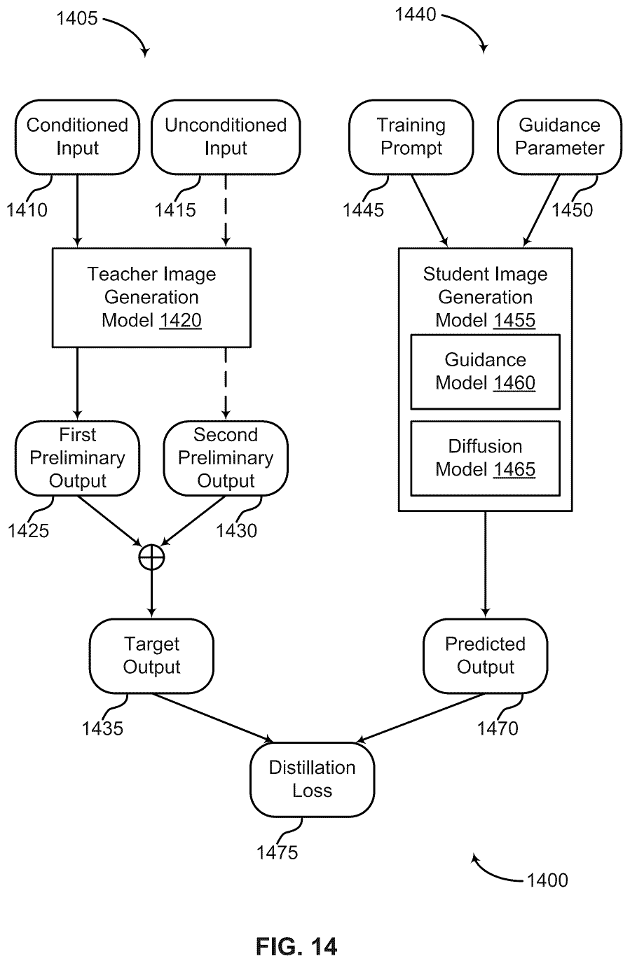

Accordingly, the present disclosure provides a system and method that improve on conventional text-to-image generation models by generating synthetic images more efficiently while maintaining the image quality. For example, the system includes a guidance model trained to generate guidance features that control the level of influence of the input conditioning (e.g., the text prompt) on the image generation process. By using the guidance features to generate the synthetic image, the inference time can be reduced while maintaining the image quality of the synthetic image. In some aspects, by training the guidance model independently of the diffusion model, the training cost of the system is reduced. In one aspect, the guidance model can be used to augment different types of fine-tuned diffusion models without additional training as described with reference to FIG. 4. In some embodiments, by progressively distillate the image generation model as described in FIG. 14, the inference time of the image generation model can be further reduced.

### Text-to-Image Generation

In FIGS. 1-5 and 12, a method, apparatus, non-transitory computer readable medium, and system for image processing include obtaining a text prompt and a guidance parameter, where the text prompt describes an image element and the guidance parameter indicates a level of guidance intensity for the text prompt, computing, using a guidance model of an image generation model, guidance features based on the text prompt and the guidance parameter, and generating, using the image generation model, a synthetic image that depicts the image element based on the text prompt and the guidance features.

Some examples of the method, apparatus, non-transitory computer readable medium, and system further include encoding the text prompt to obtain a text embedding. In some cases, the guidance features and the synthetic image are based on the text embedding. In some aspects, the guidance model is trained using a teacher model that includes a diffusion model of the image generation model.

Some examples of the method, apparatus, non-transitory computer readable medium, and system further include generating, using the image generation model, image features based on the text prompt. Some examples further include combining the guidance features and the image features to obtain combined features, where the synthetic image is generated the combined features. In some aspects, the guidance features comprise a plurality of layer-specific guidance feature maps corresponding to a plurality of decoding layers of the image generation model, respectively.

Some examples of the method, apparatus, non-transitory computer readable medium, and system further include obtaining a noise map. Some examples further include denoising the noise map based on the text prompt and the guidance features to obtain the synthetic image. In some aspects, the guidance features are computed independently of the noise map.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 6.

Referring to FIG. 1, user 100 provides a text prompt and a value of a guidance parameter to image processing apparatus 110 110 via user device 105 and cloud 115 to generate a synthetic image. For example, the text prompt states “A panda eating bamboo”. In some cases, the guidance value indicates a level of guidance intensity for the text prompt. For example, as the value of the guidance parameter increases, the image generation process becomes more directed towards satisfying the conditions. In some aspects, image processing apparatus 110 includes a guidance model trained to generate guidance features based on the text prompt and the guidance parameter. In some aspects, image processing apparatus 110 includes an image generation model that generates image features based on the text prompt. Then, the guidance features are combined with the image feature in the decoding layers of the image generation model to generate the synthetic image. For example, the synthetic image depicts a panda holding a batch of bamboo on one hand and eating a bamboo using the other hand. In some cases, image processing apparatus 110 displays the synthetic image to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 6. According to some aspects, image processing apparatus 110 includes a computer implemented network comprising a machine learning model, a text encoder, a guidance model, and an image generation model. Image processing apparatus 110 further includes a processor unit, a memory unit, and an I/O module. In some embodiments, image processing apparatus 110 further includes a communication interface, user interface components, and a bus as described with reference to FIG. 18. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data including a training prompt, a training image, and a guidance parameter. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for text conditional image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides a text prompt and a guidance parameter to the image processing apparatus (e.g., the image processing apparatus described with reference to FIGS. 1 and 6) to generate a synthetic image. For example, the text prompt states “A panda eating bamboo.” In some cases, the guidance parameter is represented as a numerical value between 2 to 9. For example, the lower the guidance parameter, the less noticeable the feature map injections, and resulting in weaker influence of the text prompt on the image generation. In contrast, the higher the guidance parameter, the stronger the feature map injections, and resulting in more robust steering and control over the diffusion model. For example, the value of the guidance parameter is 8, and the value is provided to the image processing apparatus.

In some aspects, the image processing apparatus includes a guidance model trained to generate guidance features based on the text prompt and the guidance parameter. In some aspects, the guidance features include latent feature maps at different stages that capture features that are not directly from the input data (e.g., the text prompt and the guidance parameter). For example, in the earlier stage of the image generation process, the feature maps include information about the primary structure of the image. In the middle stage, the feature maps include information about the main objects (e.g., bamboo and panda) described in the text prompt. In the final stage, the feature maps focus on detail refinement of the edges.

In some aspects, the image processing apparatus includes a diffusion model configured to generate image features based on the text prompt. In some cases, the image features are combined with the guidance features at each corresponding decoding layer of the diffusion model. In some cases, the image generation model generates a synthetic image based on the combined features. For example, the synthetic image depicts a panda holding a batch of bamboo on one hand and eating bamboo using the other hand. The synthetic image is provided to the user via an image generation apparatus.

At operation 205, the system provides text prompt and guidance parameter. In some cases, the operations of this step refer to, or may be performed by, a user as described with reference to FIG. 1. For example, the user provides a text prompt and a value that indicates the guidance parameter to the system. In some cases, the guidance parameter indicates a level of guidance intensity for the text prompt. For example, a high value of the guidance parameter indicates a strong feature map injection to the image generation model.

At operation 210, the system generates conditional guidance embeddings. In some cases, the operations of this step refer to, or may be performed by, an image processing apparatus as described with reference to FIGS. 1 and 6. In some cases, the operations of this step refer to, or may be performed by, a guidance model as described with reference to FIGS. 4, 6-9, and 14. In some embodiments, the system includes a text encoder configured to generate a text embedding based on the text prompt. In some embodiments, the system includes a guidance model trained to generate a guidance feature based on the text prompt (or text embedding) and the guidance parameter.

In some cases, the guidance features enable the diffusion model to generate text-conditioned images in one path. In some aspects, the guidance features include latent feature maps that include different types of information at different stages of the image generation process. For example, in classifier-free guidance (CFG), the latent feature maps include information about the primary structure and the main object to be generated in the early and middle stages of the image generation process. Additionally, information from these latent feature maps is substantially influenced based on the text prompt and the guidance parameter.

In some embodiments, the diffusion model generates image features based on the text prompt. The image features are combined with the guidance features at each of the decoding layers of the diffusion model to generate the combined features. For example, the image features include visual information described by the text prompt, and the guidance features include information of how much guidance should the model follow the text prompt. In some cases, the diffusion model generates a synthetic image based on the combined features.

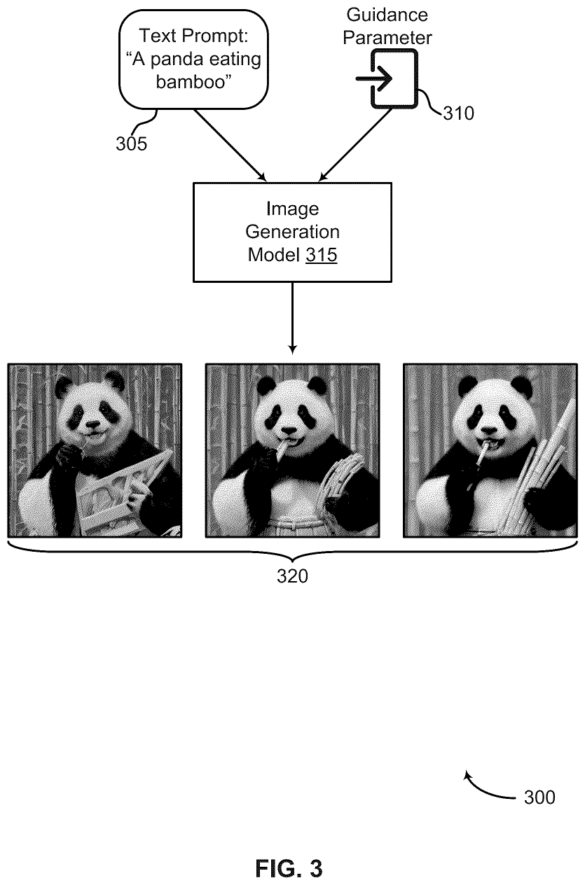

At operation 215, the system initializes noises input. In some cases, the operations of this step refer to, or may be performed by, an image processing apparatus as described with reference to FIGS. 1 and 6. In some cases, the operations of this step refer to, or may be performed by, an image generation model as described with reference to FIGS. 3, 4, 6, and 7. In some cases, the noise input including random noise is initialized. The noise input may be in a latent space. By initializing the image generation model with random noise, different variations of a synthetic image including the content described by the text conditioning (e.g., the text prompt) can be generated.

At operation 220, the system generates media content. In some cases, the operations of this step refer to, or may be performed by, an image processing apparatus as described with reference to FIGS. 1 and 6. In some cases, the operations of this step refer to, or may be performed by, an image generation model as described with reference to FIGS. 3, 4, 6, and 7. In some cases, the media content includes a synthetic image. For example, the image generation model generates a synthetic image based on the combined features. In some embodiments, the synthetic image is generated using a reverse diffusion process as described with reference to FIG. 12. Then, the synthetic image is returned and displayed to the user via a user interface provided by the image processing apparatus on the user device.

FIG. 3 shows an example of text-to-image generation according to aspects of the present disclosure. The example shown includes image generation system 300, text prompt 305, guidance parameter 310, image generation model 315, and synthetic images 320. In some embodiments, image generation system 300 is implemented in a user interface.

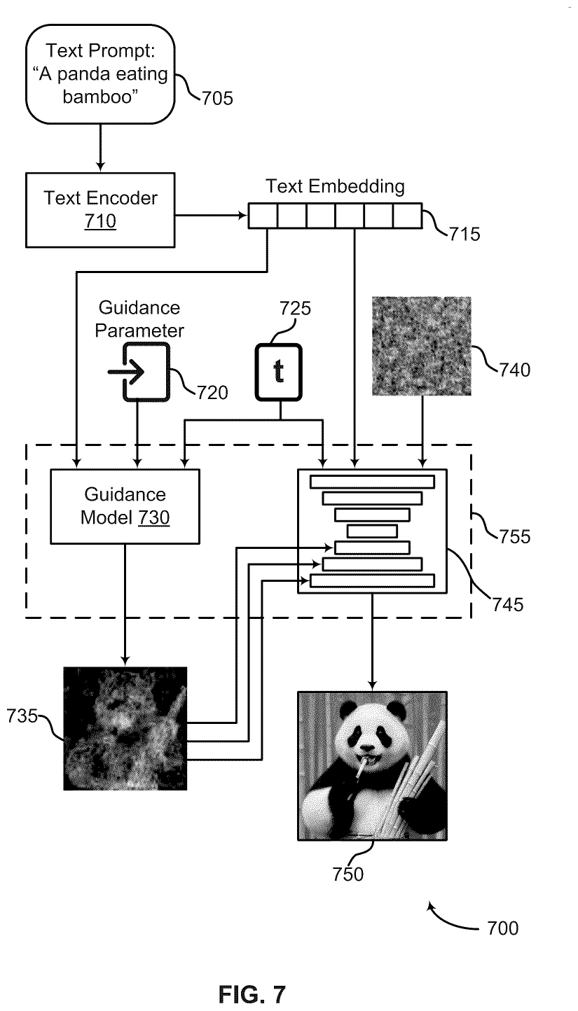

Referring to FIG. 3, image generation system 300 generates one or more synthetic images 320 based on the text prompt 305 and the guidance parameter 310. For example, the text prompt 305 states “A panda eating bamboo”. In some cases, for example, the values of the guidance parameter are 2, 6, and 8 corresponding to the three synthetic images 320, respectively. In some embodiments, the image generation system 300 includes a text encoder that encodes the text prompt 305 to generate a text embedding. In some aspects, the image generation model 315 includes a guidance model that takes the text embedding and the guidance parameter and generates one or more guidance features. In some cases, the guidance features include one or more layer-specific latent feature maps corresponding to the one or more decoding layers of the image generation model 315. Further detail on the structure of the image generation model 315 is described with reference to FIGS. 7 and 10-11.

According to some embodiments, the guidance features are combined with the image features, generated based on the text prompt, in each decoding layer of the image generation model 315. Then, the image generation model 315 generates a plurality of synthetic images 320 each corresponding to an input value of the guidance parameter 310. For example, the first synthetic image (e.g., the left-most image) among the synthetic images 320 corresponds to a guidance parameter of 2. For example, the second synthetic image (e.g., the middle image) among the synthetic images 320 corresponds to a guidance parameter of 6. For example, the third synthetic image (e.g., the right-most image) among the synthetic images 320 corresponds to a guidance parameter of 8.

According to some aspects, image generation model 315 of the present disclosure is able to generate images with substantially the same image quality as images generated by a large image generation model, while using half the inference time. In some cases, the large image generation model is trained on large amount of training data and has a large number of network parameters. In some embodiments, by using the guidance model of the image generation model 315, the image quality of the synthetic images 320 can be maintained at a substantially the same level while reducing the number of diffusion timesteps.

Image generation system 300 is an example of, or includes aspects of, the corresponding element described with reference to FIG. 4. Text prompt 305 is an example of, or includes aspects of, the corresponding element described with reference to FIGS. 4, 7, and 10. Guidance parameter 310 is an example of, or includes aspects of, the corresponding element described with reference to FIGS. 7-9, and 14. Image generation model 315 is an example of, or includes aspects of, the corresponding element described with reference to FIGS. 4, 6, and 7.

FIG. 4 shows an example of text-to-image generation using trained diffusion models according to aspects of the present disclosure. The example shown includes image generation system 400, text prompt 405, image generation model 410, first synthetic image 425, second synthetic image 430, and third synthetic image 435. In one aspect, image generation model 410 includes guidance model 415 and pre-trained diffusion model 420.

Referring to FIG. 4, image generation system 400 receives a text prompt 405 and generates a plurality of synthetic images (e.g., first synthetic image 425, second synthetic image 430, and third synthetic image 435) based on the type of pre-trained diffusion model 420. For example, image generation model 410 includes a guidance model 415 that can be augmented to a pre-trained diffusion model 420 without additional training. In some cases, by using the guidance model 415, the processing time of the pre-trained diffusion model 420 can be reduced.

In an embodiment, for example, the pre-trained diffusion model 420 is pretrained on 3D cartoon style. Image generation model 410 takes the text prompt 405 stating “A blue-white bird standing on a tree branch” to generate first synthetic image 425 depicting the bird in the 3D cartoon style. In some cases, the guidance parameter is provided to image generation model 410 to modify the level of guidance intensity for the text prompt and the style intensity. In one aspect, by using the guidance model 415, the pre-trained diffusion model 420 is ran once during each diffusion timestep in the reverse diffusion process instead of twice (once for the conditional forward pass and the second for the unconditional forward pass). Accordingly, the processing time for the pre-trained diffusion model 420 is reduced while maintaining substantially the same image quality of the first synthetic image 425.

In an embodiment, for example, the pre-trained diffusion model 420 is pretrained on watercolor style. Image generation model 410 takes the text prompt 405 to generate a second synthetic image 430 depicting the bird in the watercolor style. In an embodiment, for example, the pre-trained diffusion model 420 is pretrained on realistic style. Image generation model 410 takes the text prompt 405 to generate third synthetic image 435 depicting the bird in the realistic style. In some cases, the guidance parameter is provided to image generation model 410 to modify the level of guidance intensity for the text prompt and the style intensity.

According to some embodiments, the guidance model 415 can be used to augment different types of fine-tuned diffusion models (e.g., the pre-trained diffusion model 420) without additional training. In some cases, the guidance model 415 generates latent representation of the guidance parameter, which has significant adaptability to various types of diffusion models. By combining the guidance model 415 with the fine-tuned diffusion models, the system (including the guidance model 415 and the fine-tuned diffusion models) can process without classifier-free guidance and pass the guidance value (an internal guidance parameter of the fine-tuned diffusion models) to the guidance model 415. Accordingly, the image generation process can be performed efficiently without additional cost.

According to some embodiments, the system is evaluated, and the performance result indicates that the system of the present disclosure is more efficient than conventional image generation models while maintaining a substantially the same image quality level. In addition, the guidance model 415 of the present disclosure can be generalized and augmented to different types of trained models without additional training, and thus reducing the training cost. In some cases, outputs of the image generation model 410 are compared with the conventional outputs generated from the conventional image generation models using the same initial noise. The outputs of the image generation model 410 present a stronger contrast compared to the conventional outputs.

Image generation system 400 is an example of, or includes aspects of, the corresponding element described with reference to FIG. 3. Text prompt 405 is an example of, or includes aspects of, the corresponding element described with reference to FIGS. 3, 7, and 10. Image generation model 410 is an example of, or includes aspects of, the corresponding element described with reference to FIGS. 3, 6, and 7. Guidance model 415 is an example of, or includes aspects of, the corresponding element described with reference to FIGS. 6-9, and 14.

FIG. 5 shows an example of a method 500 for generating a synthetic image based on guidance features according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system obtains a text prompt and a guidance parameter, where the text prompt describes an image element, and the guidance parameter indicates a level of guidance intensity for the text prompt. In some cases, the operations of this step refer to, or may be performed by, an image generation model as described with reference to FIGS. 3, 4, 6, and 7. In some cases, the text prompt describes one or more image elements to be generated in the synthetic image. For example, an image element is an image component or image feature that makes up the overall composition of an image, such as an object, entity, subject, shape, color, texture, pattern, background scene, visual attributes, and/or style.

In some cases, for example, the guidance parameter is represented as a numerical value that indicates a level of guidance intensity. For example, the guidance parameter indicates how much guidance signal is to be integrated into the image generation process. In some cases, the guidance parameter controls how much weight is given to different types of guidance signals, such as textual description, that steers the image generation process. In some cases, the higher the guidance parameter indicates a stronger weight on a guidance signal (e.g., more latent feature map injection) and leads to more pronounced effects on the generated images. On the other hand, the lower the guidance parameter leads to less influence from the guidance signal and may result in more subtle adjustments in the generated images.

At operation 510, the system computes, using a guidance model of an image generation model, guidance features based on the text prompt and the guidance parameter. In some cases, the operations of this step refer to, or may be performed by, a guidance model as described with reference to FIGS. 4, 6-9, and 14. In some cases, each of the guidance features includes a guidance feature map. In some embodiments, the system includes a text encoder configured to encode the text prompt to generate a text embedding. In some cases, the guidance features are generated based on the text embedding and the guidance parameter. For example, the text embedding is a numeral representation of text that captures semantic meaning and relationships of words in a continuous vector space or embedding space. Vector space provides a framework for representing and manipulating data (in the form of vectors), computing distances between vectors, and transforming input data for complex relationships. The dimensionality of the vector space is determined by the number of features in the feature vector. For example, if each data point has three features (e.g., length, width, and height), the vector space is three-dimensional. In some cases, a joint vector space includes a high-dimensional vector space and a low-dimensional vector space. In some cases, the text embedding is in a low-dimensional vector space.

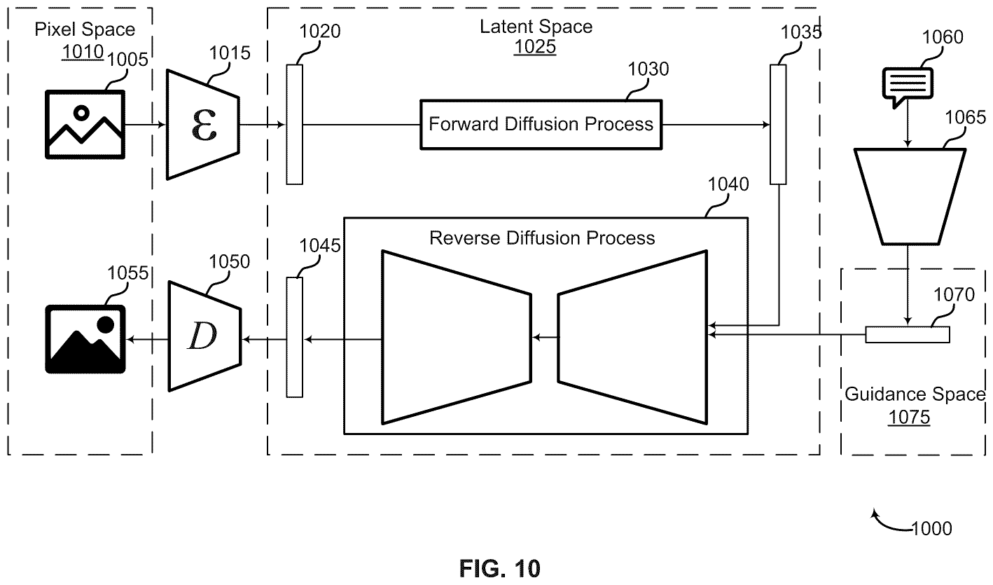

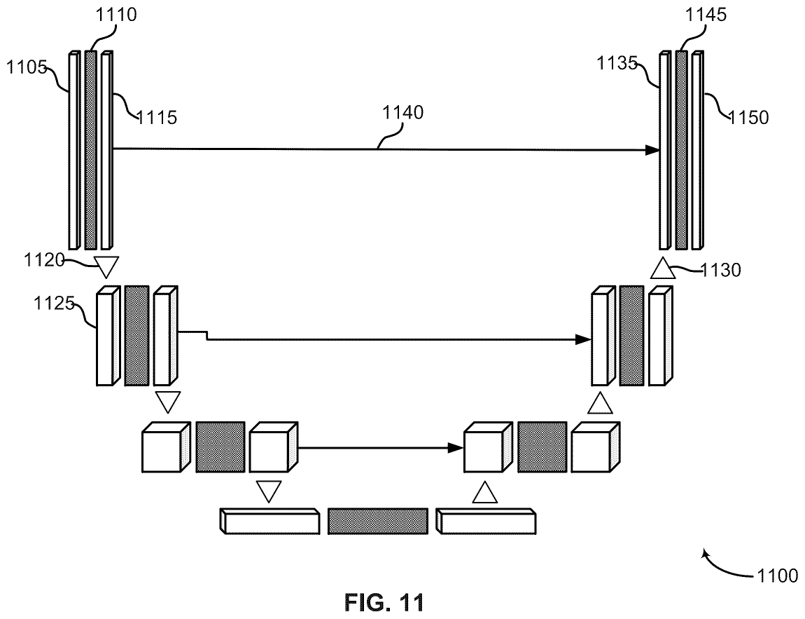

In some cases, the guidance features include a plurality of layer-specific guidance feature maps that respectively correspond to a plurality of decoding layers of the image generation model. For example, the guidance feature map (also referred to as the latent feature map) is a representation of data in a latent space, where the latent feature map captures features and patterns that are not directly from the input data (e.g., the text prompt and the guidance parameter). Further detail on the architecture of the image generation model is described with reference to FIGS. 10-11.

In some cases, the latent feature map includes different types of information during different stages of the image generation process. For example, in the earlier stage of the image generation process, the feature maps include information about the primary structure of the image. In the middle stage, the feature maps include information about the main objects (e.g., bamboo and panda) described in the text prompt. In the final stage, the feature maps focus on detail refinement of the edges. In some cases, information from the latent feature maps is substantially influenced based on the text prompt and the guidance parameter.

At operation 515, the system generates, using the image generation model, a synthetic image that depicts the image element based on the text prompt and the guidance features. In some cases, the operations of this step refer to, or may be performed by, an image generation model as described with reference to FIGS. 3, 4, 6, and 7. During the reverse diffusion process, the image features generated based on the text prompt and the guidance features are combined to obtain the combined features. The image generation model iteratively denoises the combined features to obtain the synthetic image. In some cases, one or more synthetic images are generated based on the text prompt and one guidance parameter. In some cases, multiple guidance parameters are provided to generate multiple synthetic images each corresponding to each of the guidance parameters.

### System Architecture

In FIGS. 6-11 and 18, an apparatus and system for image processing include at least one processor, at least one memory storing instructions executable by the at least one processor, and an image generation model comprising parameters stored in the at least one memory, where the image generation model is trained to generate a synthetic image that depicts an image element based on a text prompt, and where the image generation model comprises a guidance model trained to compute guidance features based on the text prompt and a guidance parameter that indicates a level of guidance intensity for the text prompt.

Some examples of the apparatus and system further include a text encoder configured to encode the text prompt to obtain a text embedding. In some aspects, the image generation model comprises a diffusion model. In some aspects, the guidance model has fewer parameters than the diffusion model. In some aspects, the guidance model comprises a plurality of zero convolutional layers. In some aspects, the guidance model takes the guidance parameter as an input.

FIG. 6 shows an example of an image processing apparatus 600 according to aspects of the present disclosure. The example shown includes image processing apparatus 600, processor unit 605, I/O module 610, memory unit 615, text encoder 620, guidance model 625, image generation model 630, training component 635, and teacher model 640. In one aspect, memory unit 615 includes text encoder 620, guidance model 625, and image generation model 630.

According to some embodiments of the present disclosure, image processing apparatus 600 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 600 is an example of, or includes aspects of, the corresponding element described with reference to FIG. 1.

Processor unit 605 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 605 is configured to operate a memory array using a memory controller. In other cases, a memory controller is integrated into the processor. In some cases, processor unit 605 is configured to execute computer-readable instructions stored in a memory to perform various functions. In some embodiments, processor unit 605 includes special-purpose components for modem processing, baseband processing, digital signal processing, or transmission processing. Processor unit 605 is an example of, or includes aspects of, the processor described with reference to FIG. 18.

I/O module 610 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 610 includes a user interface. A user interface may enable a user to interact with a device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 610 is an example of, or includes aspects of, the I/O interface described with reference to FIG. 18.

Examples of memory unit 615 include random access memory (RAM), read-only memory (ROM), or a hard disk. Examples of memory unit 615 include solid-state memory and a hard disk drive. In some examples, memory unit 615 is used to store computer-readable, computer-executable software including instructions that, when executed, cause a processor to perform various functions described herein.

In some cases, memory unit 615 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 615 store information in the form of a logical state.

According to some aspects, memory unit 615 includes a machine learning model. In one aspect, the machine learning model includes text encoder 620, guidance model 625, and image generation model 630. Memory unit 615 is an example of, or includes aspects of, the memory subsystem described with reference to FIG. 18.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 615 and executable by processor unit 605, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence), and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, which allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, text encoder 620 is implemented as software stored in memory unit 615 and executable by processor unit 605, as firmware, as one or more hardware circuits, or as a combination thereof. According to some aspects, text encoder 620 encodes the text prompt to obtain a text embedding, where the guidance features and the synthetic image are based on the text embedding. According to some aspects, text encoder 620 is configured to encode the text prompt to obtain a text embedding. Text encoder 620 is an example of, or includes aspects of, the corresponding element described with reference to FIGS. 7 and 10.

According to some aspects, guidance model 625 is implemented as software stored in memory unit 615 and executable by processor unit 605, as firmware, as one or more hardware circuits, or as a combination thereof. According to some aspects, guidance model 625 computes guidance features based on the text prompt and the guidance parameter. In some aspects, the guidance features include a set of layer-specific guidance feature maps corresponding to a set of decoding layers of the image generation model 630, respectively. In some aspects, the guidance features are computed independently of the noise map. In some aspects, the guidance model 625 is trained using a teacher model that includes a diffusion model of the image generation model 630.

In some aspects, the guidance model 625 has fewer parameters than the diffusion model. In some aspects, the guidance model 625 includes a set of zero convolutional layers. In some aspects, the guidance model 625 takes the guidance parameter as an input. Guidance model 625 is an example of, or includes aspects of, the corresponding element described with reference to FIGS. 4, 7-9, and 14.

According to some aspects, image generation model 630 is implemented as software stored in memory unit 615 and executable by processor unit 605, as firmware, as one or more hardware circuits, or as a combination thereof. According to some aspects, image generation model 630 obtains a text prompt and a guidance parameter, where the text prompt describes an image element, and the guidance parameter indicates a level of guidance intensity for the text prompt. In some examples, image generation model 630 generates a synthetic image that depicts the image element based on the text prompt and the guidance features. In some examples, image generation model 630 generates image features based on the text prompt. In some examples, image generation model 630 combines the guidance features and the image features to obtain combined features, where the synthetic image is generated the combined features. In some examples, image generation model 630 obtains a noise map. In some examples, image generation model 630 denoises the noise map based on the text prompt and the guidance features to obtain the synthetic image. According to some aspects, image generation model 630 generates a predicted output.

According to some aspects, image generation model 630 comprises parameters stored in the at least one memory, wherein the image generation model 630 is trained to generate a synthetic image that depicts an image element based on a text prompt, and wherein the image generation model 630 comprises a guidance model 625 trained to compute guidance features based on the text prompt and a guidance parameter that indicates a level of guidance intensity for the text prompt. In some aspects, the image generation model 630 includes a diffusion model. Image generation model 630 is an example of, or includes aspects of, the corresponding element described with reference to FIGS. 3, 4, and 7.

According to some aspects, training component 635 is implemented as software stored in memory unit 615 and executable by processor unit 605, as firmware, as one or more hardware circuits, or as a combination thereof. According to some embodiments, training component 635 is implemented as software stored in a memory unit and executable by a processor in the processor unit of a separate computing device, as firmware in the separate computing device, as one or more hardware circuits of the separate computing device, or as a combination thereof. In some examples, training component 635 is part of another apparatus other than image processing apparatus 600 and communicates with the image processing apparatus 600. In some examples, training component 635 is part of image processing apparatus 600.

According to some aspects, training component 635 obtains a training set including a training prompt, a training image, and a guidance parameter, where the training prompt describes an image element, the training image depicts the image element, and the guidance parameter indicates a level of guidance intensity for the training prompt. In some examples, training component 635 trains, using the training set, an image generation model 630 to generate a synthetic image that depicts the image element based on the guidance parameter, where the image generation model 630 includes a guidance model 625 that computes guidance features based on the guidance parameter and a diffusion model that generates the synthetic image based on the guidance features.

In some examples, training component 635 obtains a teacher model 640 that includes the diffusion model of the image generation model 630, where the image generation model 630 is trained as a student model of the teacher model 640. In some examples, training component 635 computes a distillation loss based on the target output and the predicted output. In some examples, training component 635 updates parameters of the image generation model 630 based on the distillation loss. In some examples, training component 635 updates parameters of the guidance model 625. In some examples, training component 635 freezes parameters of the diffusion model. In some examples, training component 635 trains the image generation model 630 based on a first number of timesteps during a first training stage. In some examples, training component 635 trains the image generation model 630 based on a second number of timesteps during a second training stage.

According to some aspects, teacher model 640 implemented as software stored in a memory unit and executable by a processor in the processor unit of a separate computing device, as firmware in the separate computing device, as one or more hardware circuits of the separate computing device, or as a combination thereof. In some examples, teacher model 640 is part of another apparatus other than image processing apparatus 600 and communicates with the image processing apparatus 600.

According to some aspects, teacher model 640 is a pre-trained diffusion model used to train image generation model 630 in the distillation process (e.g., diffusion distillation described with reference to FIG. 14). In some aspects, teacher model 640 is a heavy diffusion model (in terms of parameters) that guides the training of a student model (e.g., image generation model 630). In some cases, the teacher model 640 generates examples of the desired output by performing the diffusion process, and the examples are used to train the student model to mimic the performance of the teacher model 640. In one aspect, the goal of the student model is to generate high-quality outputs more efficiently by distilling the knowledge and behavior of the teacher model 640. In some cases, the student model includes fewer parameters than the teacher model 640.

According to some aspects, teacher model 640 generates a target output. In some examples, teacher model 640 generates a first preliminary output based on the training prompt. In some examples, teacher model 640 generates a second preliminary output independent of the training prompt. In some examples, teacher model 640 combines the first preliminary output and the second preliminary output based on the guidance parameter to obtain the target output. In some aspects, the first preliminary output and the second preliminary output are independent of the guidance parameter. Teacher model 640 is an example of, or includes aspects of, the corresponding element described with reference to FIG. 14.

FIG. 7 shows an example of a machine learning system according to aspects of the present disclosure. The example shown includes machine learning system 700, text prompt 705, text encoder 710, text embedding 715, guidance parameter 720, timestep embedding 725, guidance model 730, guidance features 735, noise input 740, diffusion model 745, synthetic image 750, and image generation model 755. In one aspect, machine learning system 700 includes text encoder 710 and image generation model 755. In one aspect, image generation model 755 includes guidance model 730 and diffusion model 745.

Referring to FIG. 7, machine learning system 700 receives text prompt 705 and guidance parameter 720 to generate synthetic image 750. For example, text encoder 710 receives text prompt 705 and generates text embedding 715. In some cases, text prompt 705 states “A panda eating bamboo.” In some cases, text embedding 715 includes information about the text prompt 705 that is represented as a numerical vector.

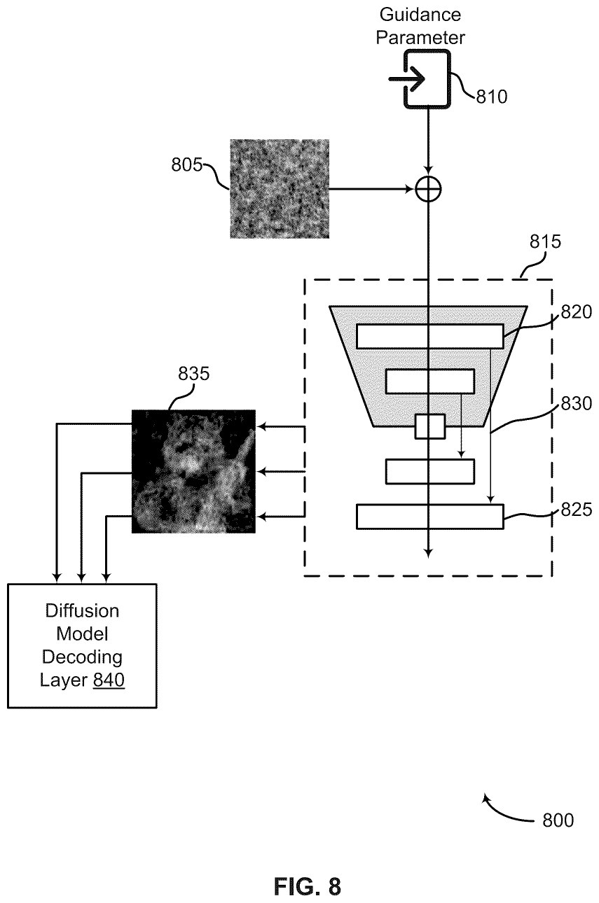

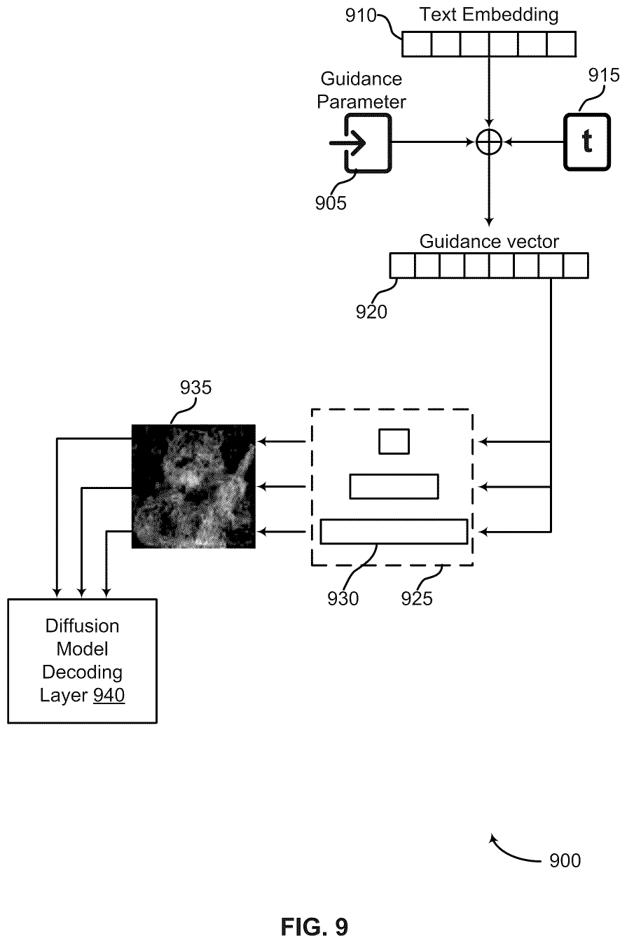

According to some embodiments, the text embedding 715 is used as input to the image generation model 755 for the image generation process. For example, image generation model 755 includes a guidance model 730. The guidance model 730 receives the text embedding 715, the guidance parameter 720, and timestep embedding 725 to generate guidance features 735. In some cases, the guidance model 730 generates a plurality of layer-specific guidance features that are used as inputs to the decoding layers of the diffusion model 745. In the example shown in FIG. 7, guidance model 730 generates three layer-specific guidance features (e.g., guidance features 735), where each of the layer-specific guidance features may be different from each other. In some cases, each of the guidance features 735 includes a latent feature map. Further detail on the guidance model 730 is described with reference to FIGS. 8 and 9.

According to some embodiments, different values of the guidance parameter 720 at different stages of the reverse diffusion process affect the generation of latent feature map (e.g., guidance features 735). In some cases, different latent features maps are able to impact the CFG image generation. For example, for each decoding layer of the diffusion model 745, where the latent feature map is injected, the system computes the mean across various channels for each pixel and applies normalization. In some cases, for example, the number of diffusion steps for the sampling process is fifty.

According to some aspects, during the initial stage of the reverse diffusion process where the primary structures are formed, CFG is an important element with respect to the guidance features 735. During the middle stage, the main subjects of the image (e.g., panda and bamboo) are more important, whereas the background elements are less significant. During the last stage, the guidance features focus on detail refinement on the edges. According to some aspects, the lower the guidance parameter 720, the less noticeable the feature map injections, and resulting in weaker influence of the text prompt 705 on the image generation. Additionally, the higher the guidance parameter 720, the stronger the feature map injections, and resulting in more robust steering and control over the diffusion model 745.

In some embodiments, the text embedding 715, timestep embedding 725, and the noise input 740 are provided to the diffusion model 745 of the image generation model 755. During the reverse diffusion process, diffusion model 745 iteratively denoises the noise input 740 to generate an intermediate image or an intermediate feature, and during the final diffusion step, the diffusion model 745 generates a clean image. The text embedding 715 are used to guide the diffusion process by combining the text embedding 715 and the noise input 740 (or noisy image during the intermediate diffusion steps) via concatenation, addition, or cross-attention mechanism. During the diffusion process, timestep embedding 725 is used to progressively add and remove noise in a controlled manner, providing a temporal structure that stabilizes training and guide inference. Each timestep or timestep embedding 725 corresponds to a specific noise level, enabling the diffusion model 745 to learn to denoise incrementally. This approach enables the diffusion model 745 to effectively reconstruct the original data from noisy versions.

During the reverse diffusion process (also sometimes referred to as the denoising process), a U-Net is used to denoise the noise input 740. For example, the U-Net takes the noise input 740 and the text embedding as input and removes noise through a series of convolutional layers, and downsamples the noise input 740 (or an intermediate image during the intermediate steps) while capturing the important features and noise patterns. Then, at the lowest resolution layer, the convolutional layer takes other guidance such as text embedding 715 and guidance features 735 to further guide the denoising process. Then, the decoding layers of the U-Net upsamples the features back to the original resolution using a series of convolutional layers. In some cases, each of the guidance features 735 are added to the image feature at each of the decoding layers. Further detail on the structure of the U-Net is described with reference to FIG. 11.

Diffusion models are a class of generative models that generate synthetic images by iteratively adding noise to an original image and iteratively removes the added noise to generate high-quality images. Under continuous time setting, where t˜Uniform [0,1], the diffusion model ϵ_{φ} (e.g., diffusion model 745) is trained to approximate noise given the diffused noisy real data x˜p_{data}:

$${𝔼}_{t , ϵ , x} [ w ( {λ}_{t} ) {‖ {ϵ}_{ϕ} ( {x}_{t} ) - ϵ ‖}_{2}^{2} ] \qquad ( 1 )$$

where

$$w ( {λ}_{t} ) = w ( log ( {α}_{t}^{2} / {σ}_{t}^{2} ) )$$

is a predetermined weighted function that takes into the signal-to-noise ratio λₜ, which decreases monotonically with time t, and where xₜ is a latent variable that satisfied

$$x ∼ q ( {x}_{t} \vert x ) = ( {x}_{t} ; {α}_{t} x , {σ}_{t}^{2} I ) .$$

After training the diffusion model ϵ_{φ}, during the sampling stage, xₜ can be obtained by applying Stochastic Differential Equation (SDE) or the Ordinary Differential Equation (ODE). In some cases, for example, the diffusion model ϵ_{φ} uses Denoising Diffusion Implicit Models (DDIM) approach as follows:

$${x}_{t} = {α}_{t} {ϵ}_{ϕ} ( {x}_{t} ) + {σ}_{t} \frac{{x}_{t} - {α}_{t} {ϵ}_{ϕ} ( {x}_{t} )}{{σ}_{t}} , s = t - \frac{1}{N} \qquad ( 2 )$$

where N is the total number of sampling steps and x₁˜ [symbol] (0, 1).

In the field of image processing, classifier-free guidance (CFG) method is used to enhance the quality of images in class-conditioned diffusion models. For example, the model adopted an unconditioned class identifier φ as a substitute for a separate classifier that creates a Gaussian distribution tailored to a specific class. In some cases, conventional models like Stable Diffusion, design the forward diffusion process and the reverse diffusion process in the variational autoencoder (VAE) latent space z=E(x), x=D(z) where E and D represent the VAE encoder and decoder. For example, in the image generation process, CFG carries out evaluations on both conditional score predictions and unconditional score predictions. For example, the computation of the noise sample, \tilde{ϵ}_{φ} (zₜ, c) follows:

$${\tilde{ϵ}}_{ϕ} ( {z}_{t} , c ) = ( 1 + g ) {ϵ}_{ϕ} ( {z}_{t} , c ) - g {ϵ}_{ϕ} ( {z}_{t} , ϕ ) \qquad ( 3 )$$

where ϵ_{φ} is the score estimation function that is a parameterized neural network (e.g., the U-Net described with reference to FIG. 11), where ϵ_{φ} (zₜ, c) represents the text-conditioned term, and where ϵ_{φ} (zₜ, φ) represents the unconditioned term (e.g., null text). In some cases, the parameter g (e.g., the guidance parameter 720) represents the guidance value that scales the perturbation.

According to some embodiments, the image generation model 755 is trained to learn the following:

$${{ϵ}^{′}}_{θ} ( {z}_{t} , c ; G ( g , ( {z}_{t} , c ) ) ) = ( 1 + g ) {ϵ}_{ϕ} ( {z}_{t} , c ) - {gϵ}_{ϕ} ( {z}_{t} , ϕ ) \qquad ( 4 )$$

where g is the guidance parameter 720, G is the guidance model 730, ϵ_{φ} (zₜ, φ) is the unconditioned U-Net forward pass, and ϵ_{φ} (zₜ, c) is the conditioned U-Net forward pass. For example, guidance model 730 takes guidance parameter 720 as input, along with time and text embeddings and noise input (or intermediate features during the intermediate diffusion process), and then generates the guidance features 735. In some cases, the guidance features 735 are injected to the decoding layers of the U-Net of the diffusion model 745. In some cases, for example, the feature map injection (e.g., the injection of the guidance features 735) provides “guidance strength” to the U-Net that determines the trade-off between the sample quality and diversity.

In some embodiments, distillation involves initializing a new model that has the same structure as the teacher model and making the student model to learn the outputs of the teach model. In some cases, the entire parameters of the student network are updated. However, this process is inefficient and computationally cost ineffective. Embodiments of the present disclosure includes a guidance model 730 that reduces computational overhead during training because the number of parameters in the guidance model 730 is relatively small compared to the entire U-Net of the diffusion model 745 of the image generation model 755. Additionally or alternatively, the image generation model 755 includes the trained guidance model 730 and the U-Net of the teacher model (e.g., the diffusion model 745) for faster inference without CFG. Accordingly, guidance model 730 can be used to augment other types of fine-tuned diffusion model without re-training the guidance model 730.

According to some embodiments, the denoise process is iteratively repeated for a number of diffusion timesteps to denoise the noisy image based on the text embedding 715, the noise input 740, and the guidance features 735 to generate synthetic image 750. In some cases, the synthetic image 750 depicts the image elements described by the text prompt 705. In some cases, the visual appearance of the synthetic image 750 aligns with the level of guidance intensity indicated by the guidance parameter 720. For example, the synthetic image 750 depicts a panda eating bamboo.

Text prompt 705 is an example of, or includes aspects of, the corresponding element described with reference to FIGS. 3, 4, and 10. Text encoder 710 is an example of, or includes aspects of, the corresponding element described with reference to FIGS. 6 and 10. Text embedding 715 is an example of, or includes aspects of, the corresponding element described with reference to FIG. 9.

Guidance parameter 720 is an example of, or includes aspects of, the corresponding element described with reference to FIGS. 3, 8, 9, and 14. Timestep embedding 725 is an example of, or includes aspects of, the corresponding element described with reference to FIG. 9. Guidance model 730 is an example of, or includes aspects of, the corresponding element described with reference to FIGS. 4, 6, 8, 9, and 14.

Guidance features 735 is an example of, or includes aspects of, the corresponding element described with reference to FIGS. 8 and 9. Noise input 740 is an example of, or includes aspects of, the corresponding element described with reference to FIG. 8. Diffusion model 745 is an example of, or includes aspects of, the corresponding element described with reference to FIGS. 10 and 14. Image generation model 755 is an example of, or includes aspects of, the corresponding element described with reference to FIGS. 3, 4, and 6.

FIG. 8 shows an example of a full guidance model 800 according to aspects of the present disclosure. The example shown includes full guidance model 800, noise input 805, guidance parameter 810, guidance model 815, encoding layer 820, decoding layer 825, skip connection 830, guidance features 835, and diffusion model decoding layer 840. In one aspect, guidance model 815 includes encoding layer 820, decoding layer 825, and skip connection 830.

Referring to FIG. 8, full guidance model 800 receives noise input 805 and guidance parameter 810 to generate guidance features 835. For example, noise input 805 and guidance parameter 810 are combined and input into the encoding layer 820 of the guidance model 815. Then, the encoding layer 820 generates an intermediate feature, where the intermediate feature is downsampled to the bottleneck convolutional layer. Then, the intermediate features are upsampled through the decoding layer 825 of the guidance model 815. For example, the upsampled intermediate features are combined with the downsampled intermediate features from the corresponding encoding layer 820 via skip connection 830. In some cases, at each decoding layer 825, the combined intermediate features output as the guidance features 835. In some embodiments, each of the guidance features 835 is provided to the diffusion model decoding layer 840.

Embodiments of the present disclosure include two guidance models. The first guidance model is a full guidance model 800 and the second guidance model is a tiny guidance model 900 as described with reference to FIG. 9. In some embodiments, the full guidance model 800 converts the guidance parameter 810 into a matrix having a dimension of (C, H, W). Accordingly, the capacity of the full guidance model 800 is enhanced.

Noise input 805 is an example of, or includes aspects of, the corresponding element described with reference to FIG. 7. Guidance parameter 810 is an example of, or includes aspects of, the corresponding element described with reference to FIGS. 3, 7, 9, and 14. Guidance model 815 is an example of, or includes aspects of, the corresponding element described with reference to FIGS. 4, 6, 7, 9, and 14. Decoding layer 825 is an example of, or includes aspects of, the corresponding element described with reference to FIG. 9.

Skip connection 830 is an example of, or includes aspects of, the corresponding element described with reference to FIG. 11. Guidance features 835 is an example of, or includes aspects of, the corresponding element described with reference to FIGS. 7 and 9. Diffusion model decoding layer 840 is an example of, or includes aspects of, the corresponding element described with reference to FIG. 9.

FIG. 9 shows an example of a tiny guidance model 900 according to aspects of the present disclosure. The example shown includes tiny guidance model 900, guidance parameter 905, text embedding 910, timestep embedding 915, guidance vector 920, guidance model 925, decoding layer 930, guidance features 935, and diffusion model decoding layer 940. In one aspect, the guidance model 925 includes decoding layer 930.

Referring to FIG. 9, tiny guidance model 900 receives guidance parameter 905 and text embedding 910 to generate guidance features 935. For example, guidance parameter 905, text embedding 910, and timestep embedding 915 are combined to generate guidance vector 920. In some cases, the guidance vector 920 is input into each decoding layer 930 of the guidance model 925. Then, each decoding layer 930 generates the guidance features 935, where the guidance features 935 include a plurality of layer-specific latent feature maps. In some cases, the guidance features 935 are provided to the diffusion model decoding layer 940. According to some embodiments, the decoding layer 930 of the guidance model 925 includes a zero convolutional layer that supports time and text embedding 910.

According to some embodiments, the tiny guidance model 900 can be represented as:

$$y = Z ( γ + Z ( {c}_{timestep} ; {θ}_{z 1} ) + Z ( {c}_{text} ; {θ}_{z 2} ) ; {θ}_{z 3} ) \qquad ( 5 )$$

where γ is the guidance embedding represented by a vector based on the guidance number g (e.g., the guidance parameter 905). In some embodiments, the timestep embedding 915 and text embedding 910 are passed through the decoding layer 930 of the guidance model 925 represented as Z (·, ·). In some cases, the decoding layer 930 includes a zero-convolution layer. In some cases, for example, the guidance parameter 905, the guidance parameter 905, text embedding 910, and timestep embedding 915 are combined and passed through the zero-convolution layer to generate the corresponding output of the guidance model y. For example, the guidance model 925 generates layer-specific latent feature maps (e.g., guidance features 935) corresponding to the decoding layers 930 of the guidance model 925, respectively. In some cases, the zero-convolution architecture ensures that undesirable noise or irrelevant features are not provided to the diffusion model decoding layer 940. In some cases, the tiny guidance model 900 is able to reduce the number of parameters because tiny guidance model 900 does not need to encode noise input 805 as shown in FIG. 8.

Guidance parameter 905 is an example of, or includes aspects of, the corresponding element described with reference to FIGS. 3, 7, 8, and 14. Text embedding 910 is an example of, or includes aspects of, the corresponding element described with reference to FIG. 7. Guidance model 925 is an example of, or includes aspects of, the corresponding element described with reference to FIGS. 4, 6-8, and 14.

Decoding layer 930 is an example of, or includes aspects of, the corresponding element described with reference to FIG. 8. Guidance features 935 is an example of, or includes aspects of, the corresponding element described with reference to FIGS. 7 and 8. Diffusion model decoding layer 940 is an example of, or includes aspects of, the corresponding element described with reference to FIG. 8.

FIG. 10 shows an example of an image generation model according to aspects of the present disclosure. The example shown includes diffusion model 1000, original image 1005, pixel space 1010, image encoder 1015, original image feature 1020, latent space 1025, forward diffusion process 1030, noisy feature 1035, reverse diffusion process 1040, denoised image feature 1045, image decoder 1050, output image 1055, text prompt 1060, text encoder 1065, guidance feature 1070, and guidance space 1075. In some examples, diffusion model 1000 describes the operation and architecture of the image generation model 630 described with reference to FIG. 6.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 1000 may take an original image 1005 in a pixel space 1010 as input and apply an image encoder 1015 to convert original image 1005 into original image feature 1020 in a latent space 1025. Then, a forward diffusion process 1030 gradually adds noise to the original image feature 1020 to obtain noisy feature 1035 (also in latent space 1025) at various noise levels.

Next, a reverse diffusion process 1040 (e.g., a U-Net ANN) gradually removes the noise from the noisy feature 1035 at the various noise levels to obtain the denoised image feature 1045 in latent space 1025. In some examples, denoised image feature 1045 is compared to the original image feature 1020 at each of the various noise levels, and parameters of the reverse diffusion process 1040 of the diffusion model are updated based on the comparison. Finally, an image decoder 1050 decodes the denoised image feature 1045 to obtain an output image 1055 in pixel space 1010. In some cases, an output image 1055 is created at each of the various noise levels. The output image 1055 can be compared to the original image 1005 to train the reverse diffusion process 1040. In some cases, output image 1055 refers to the synthetic image (e.g., described with reference to FIGS. 3-4, and 7).

In some cases, image encoder 1015 and image decoder 1050 are pre-trained prior to training the reverse diffusion process 1040. In some examples, image encoder 1015 and image decoder 1050 are trained jointly, or the image encoder 1015 and image decoder 1050 are fine-tuned jointly with the reverse diffusion process 1040.

The reverse diffusion process 1040 can also be guided based on a text prompt 1060, or another guidance prompt, such as an image, a layout, a style, a color, a segmentation map, etc. The text prompt 1060 can be encoded using a text encoder 1065 (e.g., a multimodal encoder) to obtain guidance feature 1070 in guidance space 1075. The guidance feature 1070 can be combined with the noisy feature 1035 at one or more layers of the reverse diffusion process 1040 to ensure that the output image 1055 includes content described by the text prompt 1060. For example, guidance feature 1070 can be combined with the noisy feature 1035 using a cross-attention block within the reverse diffusion process 1040.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having the same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIG. 11.

A diffusion process may also be modified based on conditional guidance. In some cases, a user provides a text prompt (e.g., text prompt 1060) describing content to be included in a generated image. In some examples, guidance can be provided in a form other than text, such as via an image, a sketch, a color, a style, or a layout. The system converts text prompt 1060 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 1000 generates an image based on the noise map and the conditional guidance vector.

A diffusion process can include both a forward diffusion process 1030 for adding noise to an image (e.g., original image 1005) or features (e.g., original image feature 1020) in a latent space 1025 and a reverse diffusion process 1040 for denoising the images (or features) to obtain a denoised image (e.g., output image 1055). The forward diffusion process 1030 can be represented as q(xₜ|xₜ₋₁), and the reverse diffusion process 1040 can be represented as p_{θ}(xₜ₋₁|xₜ). Further detail on the diffusion process is described with reference to FIG. 12.

A diffusion model 1000 may be trained using both a forward diffusion process 1030 and a reverse diffusion process 1040. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1030 in N stages. In some cases, the forward diffusion process 1030 is a fixed process where Gaussian noise is successively added to an image. In latent diffusion models, the Gaussian noise may be successively added to features (e.g., original image feature 1020) in a latent space 1025.

At each stage n, starting with stage N, a reverse diffusion process 1040 is used to predict the image or image features at stage n-1. For example, the reverse diffusion process 1040 can predict the noise that was added by the forward diffusion process 1030, and the predicted noise can be removed from the image to obtain the predicted image. In some cases, an original image 1005 is predicted at each stage of the training process.

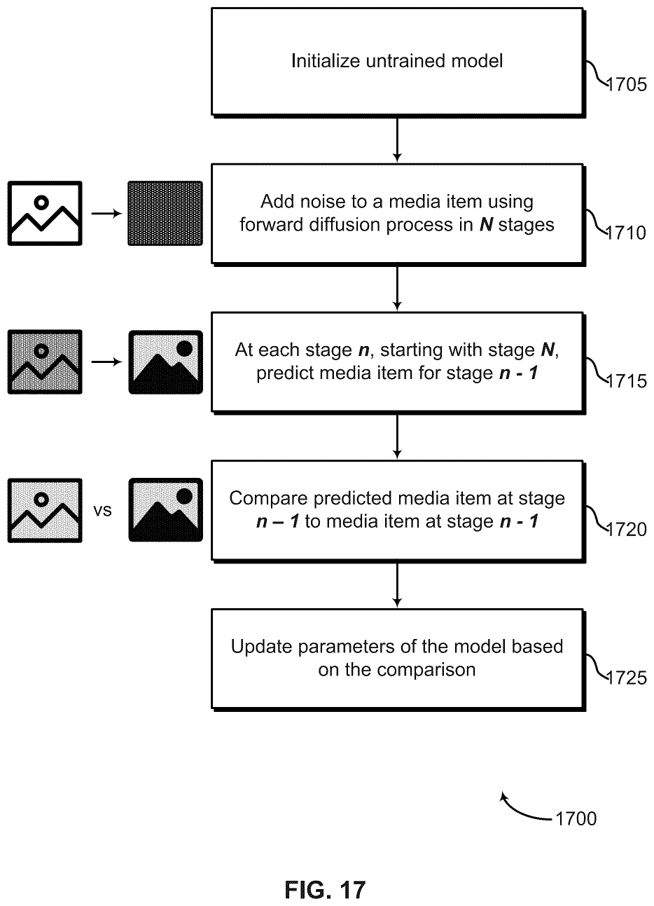

The training component (e.g., training component described with reference to FIG. 6) compares predicted image (or image features) at stage n-1 to an actual image (or image features), such as the image at stage n-1 or the original input image. For example, given observed data x, the diffusion model 1000 may be trained to minimize the variational upper bound of the negative log-likelihood −log p_{θ}(x) of the training data. The training component then updates parameters of the diffusion model 1000 based on the comparison. For example, parameters of a U-Net may be updated using gradient descent. Time-dependent parameters of the Gaussian transitions can also be learned. Further detail on training the diffusion model is described with reference to FIG. 17.

Diffusion model 1000 is an example of, or includes aspects of, the corresponding element described with reference to FIGS. 7 and 14. Original image 1005 is an example of, or includes aspects of, the corresponding element described with reference to FIG. 12. Forward diffusion process 1030 is an example of, or includes aspects of, the corresponding element described with reference to FIG. 12.

Reverse diffusion process 1040 is an example of, or includes aspects of, the corresponding element described with reference to FIG. 12. Text prompt 1060 is an example of, or includes aspects of, the corresponding element described with reference to FIGS. 3, 4, and 7. Text encoder 1065 is an example of, or includes aspects of, the corresponding element described with reference to FIGS. 6 and 7.

FIG. 11 shows an example of a U-Net 1100 architecture according to aspects of the present disclosure. The example shown includes U-Net 1100, input feature 1105, initial neural network layer 1110, intermediate feature 1115, down-sampling layer 1120, down-sampled feature 1125, up-sampling process 1130, up-sampled feature 1135, skip connection 1140, final neural network layer 1145, and output feature 1150. Skip connection 1140 is an example of, or includes aspects of, the corresponding element described with reference to FIG. 8.

In some examples, U-Net 1100 is an example of the component that performs the reverse diffusion process 1040 of diffusion model 1000 described with reference to FIG. 10 and includes architectural elements of the image generation model 630 described with reference to FIG. 6. The U-Net 1100 depicted in FIG. 11 is an example of, or includes aspects of, the architecture used within the reverse diffusion process described with reference to FIG. 10.

In some examples, diffusion models are based on a neural network architecture known as a U-Net. The U-Net 1100 takes input feature 1105 having an initial resolution and an initial number of channels and processes the input feature 1105 using an initial neural network layer 1110 (e.g., a convolutional network layer) to produce intermediate feature 1115. The intermediate feature 1115 is then down-sampled using a down-sampling layer 1120 such that the down-sampled feature 1125 has a resolution less than the initial resolution and a number of channels greater than the initial number of channels.

This process is repeated multiple times, and then the process is reversed. For example, the down-sampled feature 1125 is up-sampled using up-sampling process 1130 to obtain up-sampled feature 1135. The up-sampled feature 1135 can be combined with intermediate feature 1115 having the same resolution and number of channels via a skip connection 1140. These inputs are processed using a final neural network layer 1145 to produce output feature 1150. In some cases, the output feature 1150 has the same resolution as the initial resolution and the same number of channels as the initial number of channels.

In some cases, U-Net 1100 takes an additional input feature to produce conditionally generated output. For example, the additional input feature could include a vector representation of an input prompt. The additional input feature can be combined with the intermediate feature 1115 within the neural network at one or more layers. For example, a cross-attention module can be used to combine the additional input features and the intermediate feature 1115.

### Diffusion Process

FIG. 12 shows an example of a diffusion process 1200 according to aspects of the present disclosure. The example shown includes diffusion process 1200, forward diffusion process 1205, reverse diffusion process 1210, noisy image 1215, first intermediate image 1220, second intermediate image 1225, and original image 1230.

Diffusion process 1200 can include forward diffusion process 1205 for adding noise to original image 1230 (e.g., original image 1005 described with reference to FIG. 10) or features (e.g., original image feature 1020 described with reference to FIG. 10) in a latent space. In some aspects, diffusion process 1200 includes reverse diffusion process 1210 for denoising the noisy image 1215 (or image features) to obtain a denoised image (or original image 1230). The forward diffusion process 1205 can be represented as q(xₜ|xₜ₋₁), and the reverse diffusion process 1210 can be represented as p_{θ}(xₜ₋₁|xₜ). In some cases, the forward diffusion process 1205 is used during training to generate images with successively greater noise, and a neural network is trained to perform the reverse diffusion process 1210 (e.g., to successively remove the noise).

In an example forward diffusion process 1205 for a latent diffusion model (e.g., diffusion model 1000 described with reference to FIG. 10), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1210. During the reverse diffusion process 1210, the diffusion model begins with noisy data x_{T}, such as a noisy image 1215 and denoises the data to obtain the p_{θ}(xₜ₋₁|xₜ). At each step t-1, the reverse diffusion process 1210 takes xₜ, such as the first intermediate image 1220, and t as input. Here, t represents a step in the sequence of transitions associated with different noise levels, The reverse diffusion process 1210 outputs xₜ₋₁, such as the second intermediate image 1225, iteratively until x_{T} is reverted back to x₀, the original image 1230. The reverse diffusion process 1210 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 6 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 7 )$$

where p(x_{T})=N(x_{T}; 0, 1) is the pure noise distribution as the reverse diffusion process 1210 takes the outcome of the forward diffusion process 1205, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Forward diffusion process 1205 is an example of, or includes aspects of, the corresponding element described with reference to FIG. 10. Reverse diffusion process 1210 is an example of, or includes aspects of, the corresponding element described with reference to FIG. 10. Original image 1230 is an example of, or includes aspects of, the corresponding element described with reference to FIG. 10.

### Training and Evaluation

In FIGS. 13-17, a method, apparatus, non-transitory computer readable medium, and system for image processing include obtaining a training set including a training prompt, a training image, and a guidance parameter, where the training prompt describes an image element, the training image depicts the image element, and the guidance parameter indicates a level of guidance intensity for the training prompt and training, using the training set, an image generation model to generate a synthetic image that depicts the image element based on the guidance parameter, where the image generation model includes a guidance model that computes guidance features based on the guidance parameter and a diffusion model that generates the synthetic image based on the guidance features.

Some examples of the method, apparatus, non-transitory computer readable medium, and system further include obtaining a teacher model that includes the diffusion model of the image generation model. In some cases, the image generation model is trained as a student model of the teacher model.

Some examples of the method, apparatus, non-transitory computer readable medium, and system further include generating, using the teacher model, a target output. Some examples further include generating, using the image generation model, a predicted output. Some examples further include computing a distillation loss based on the target output and the predicted output. Some examples further include updating parameters of the image generation model based on the distillation loss.

Some examples of the method, apparatus, non-transitory computer readable medium, and system further include generating a first preliminary output based on the training prompt. Some examples further include generating a second preliminary output independent of the training prompt. Some examples further include combing the first preliminary output and the second preliminary output based on the guidance parameter to obtain the target output.

In some aspects, the first preliminary output and the second preliminary output are independent of the guidance parameter. Some examples of the method, apparatus, non-transitory computer readable medium, and system further include updating parameters of the guidance model. Some examples further include freezing parameters of the diffusion model.

Some examples of the method, apparatus, non-transitory computer readable medium, and system further include training the image generation model based on a first number of timesteps during a first training stage. Some examples further include training the image generation model based on a second number of timesteps during a second training stage.

FIG. 13 shows an example of a method 1300 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system obtains a training set including a training prompt, a training image, and a guidance parameter, where the training prompt describes an image element, the training image depicts the image element, and the guidance parameter indicates a level of guidance intensity for the training prompt. In some cases, the operations of this step refer to, or may be performed by, a training component as described with reference to FIG. 6. In some cases, the training prompt includes a description of image elements of the training image. In some cases, the training image is used as a ground-truth image to train a student image generation model as described in FIG. 14.

According to some embodiments, the training set includes a dataset from LAION (512×512). During the training stage, the guidance parameter is randomly sampled from the set g∈[2,9], and the guidance parameter is reshaped in to a matrix having a dimension of C, H, W). The guidance parameter is used as input into the guidance model. In an embodiment, where the tiny guidance model (e.g., the tiny guidance model 900 described with FIG. 9) is used, the guidance parameter is reshaped into a vector with a length of C that passes through a plurality of zero convolutional layer along with the timesteps and the text embeddings. In some embodiments, the diffusion steps are set to 1000.

At operation 1310, the system trains, using the training set, an image generation model to generate a synthetic image that depicts the image element based on the guidance parameter, where the image generation model includes a guidance model that computes guidance features based on the guidance parameter and a diffusion model that generates the synthetic image based on the guidance features. In some cases, the operations of this step refer to, or may be performed by, a training component as described with reference to FIG. 6. In some cases, the image generation model is trained using a teacher model. For example, during distillation, the knowledge from the teacher model is transferred to the student model (e.g., the image generation model). In some cases, the teacher model is a large, complex image generation model, whereas the student model is a smaller, faster image generation model. By transferring knowledge from a complex teacher model to a smaller student model, the student model is able to generate synthetic image faster and more resource-efficiently without compromising the fidelity of the generated images. Further detail on distillation is described with reference to FIG. 14.

FIG. 14 shows an example of training a student image generation model 1455 according to aspects of the present disclosure. The example shown includes distillation training 1400, teacher model 1405, conditioned input 1410, unconditioned input 1415, teacher image generation model 1420, first preliminary output 1425, second preliminary output 1430, target output 1435, student model 1440, training prompt 1445, guidance parameter 1450, student image generation model 1455, guidance model 1460, diffusion model 1465, predicted output 1470, and distillation loss 1475.

Referring to FIG. 14, target output 1435 generated from the teacher image generation model 1420 and the predicted output 1470 generated from the student image generation model 1455 are used to compute the distillation loss 1475. In some cases, the distillation loss 1475 is used to train the student image generation model 1455. For example, in classifier-free guidance (CFG) diffusion process, an image generation model performs the forward pass twice in each diffusion timestep. For example, in the first forward pass, teacher image generation model 1420 takes the conditioned input 1410 to generate the first preliminary output 1425. In some cases, the conditioned input 1410 includes a text embedding of the training prompt 1445, timestep, and noise input. For example, in the second forward pass, teacher image generation model 1420 takes the unconditioned input 1415 to generate second preliminary output 1430. In some cases, the unconditioned input 1415 includes a timestep and noise input. In some cases, the first preliminary output 1425 and the second preliminary output 1430 are combined based on a guidance factor to generate the target output 1435. In some cases, the target output 1435 includes a latent feature. In some cases, the target output 1435 includes an output image (e.g., the training image).

According to some embodiments, parameters of the guidance model 1460 of the student image generation model 1455 is initialized using the parameters of the teacher image generation model 1420. In one aspect, the student image generation model 1455 includes a guidance model 1460 and a diffusion model 1465. Then, the student image generation model 1455 takes the training prompt 1445 and the guidance parameter 1450 to generate the predicted output 1470. For example, the guidance model 1460 takes the training prompt 1445 (or a training text embedding of the training prompt 1445), the time step, and the guidance parameter 1450 to generate one or more guidance features. In one aspect, the guidance features include a plurality of layer-specific latent feature maps that correspond to a plurality of decoding layers of the diffusion model 1465. In some embodiments, the diffusion model 1465 takes the timestep and the training prompt 1445 (or a training text embedding of the training prompt 1445) to generate image features. In some cases, the image features and the guidance features are combined at each of the decoding layers of the diffusion model 1465. In some cases, the predicted output 1470 is generated based on the combined features. In some cases, the predicted output 1470 includes a latent feature. In some cases, the predicted output 1470 includes a synthetic image.

According to some aspects, the training component (e.g., the training component described with reference to FIG. 6) computes the distillation loss 1475 based on the target output 1435 and the predicted output 1470. In some cases, for example, the distillation loss 1475 includes a mean squared error (MSE) loss that calculates the average of the squares of the differences between corresponding elements of the target output 1435 and the predicted output 1470. In some cases, a large difference is penalized heavily to promote closer alignment of the two outputs. In some cases, for example, the distillation loss 1475 includes a mean absolute error (MAE) loss that calculates the average of the absolute differences between corresponding elements of the two outputs. In some cases, the differences are uniformly penalized to reduce outliers. In some cases, the distillation loss 1475 includes a perceptual loss that extracts high-level visual features from the generated image and the training image (e.g., the output image from the teacher image generation model 1420). For example, the perceptual loss is computed as the difference between the high-level features and captures the perceptually relevant discrepancies.

According to some embodiments, after training the guidance model 1460 of the student image generation model 1455, the guidance model 1460 is progressively distilled with fewer sample steps. For example, when N represents an original number of sampling steps, the student image generation model 1455 is trained to output the two forward passes from the teacher image generation model 1420 in one step. For example, the initial sampler f(z; η) maps a random noise ϵ to samples x requires N steps, is distilled into a new sampler f(z; θ) that requires N/2 steps. Then, the sampler f(z; θ) become the new teach so that the student image generation model 1455 can learn another sampler that requires N/4 steps. In some cases, this process is repeated several times until a target sampling step is obtained. In some embodiments, the parameters of the guidance model 1460 are trained and the diffusion model 1465 is frozen throughout the distillation process. Accordingly, the training time can be reduced because of the relatively small size of the guidance model 1460 compared to the diffusion model 1465 or the teacher image generation model 1420.

Teacher model 1405 is an example of, or includes aspects of, the corresponding element described with reference to FIG. 6. Guidance parameter 1450 is an example of, or includes aspects of, the corresponding element described with reference to FIGS. 3, and 7-9. Guidance model 1460 is an example of, or includes aspects of, the corresponding element described with reference to FIGS. 4, and 6-9. Diffusion model 1465 is an example of, or includes aspects of, the corresponding element described with reference to FIGS. 7 and 10.

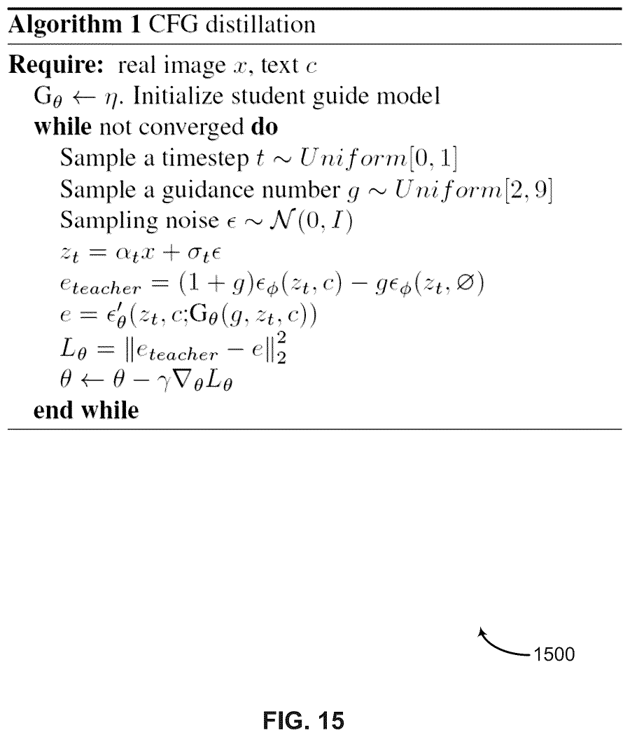

FIG. 15 shows an example of an algorithm 1500 for Classifier-free guidance (CFG) distillation according to aspects of the present disclosure. In some cases, the algorithm 1500 is implemented as code or instructions stored in at least one memory in the memory unit described with reference to FIG. 6 and can be executed by at least one processor in the processor unit described with reference to FIG. 6. In some cases, the at least one processor performs computations, logical operations, and data manipulations as specified by the algorithm 1500. In some cases, the at least one memory stores the data that the algorithm 1500 processes and the instructions of the algorithm 1500.

According to some embodiments, the algorithm 1500 performs the following functions. For example, first, real image x (e.g., training image described with reference to FIG. 13) and text c (e.g., training prompt described with reference to FIGS. 13 and 14) are provided to the system (e.g., the image generation model described with reference to FIGS. 3-4, and 6-7). Then, the system initializes the student guide model (e.g., the student image generation model described with reference to FIG. 14). For example, initialization may include setting up the initial conditions or values for variables, parameters, and data structure.

In some cases, the algorithm 1500 includes an instruction or condition for the system. For example, the instruction states the following steps. Sample a timestep t˜Uniform [0,1] instructs the system to sample a diffusion timestep. Then, sample a guidance number g˜Uniform [2,9] instructs the system to sample a value of a guidance parameter (e.g., the guidance parameter described with reference to FIG. 14) between 2 to 9, inclusive. Then, sampling a noise ϵ˜ [symbol] (0, 1) instructs the system to sample a noise input. Then, zₜ=αₜx+σₜϵ represents to apply a noise input (or intermediate images described with reference to FIG. 12) to the system. Then, e_{teacher}=(1+g)ϵ_{φ}(zₜ, c)−gϵ_{φ}(zₜ, φ) instructs the system to set the teacher image generation model (e.g., the teacher image generation model described with reference to FIG. 14). Then, e=\acute{ϵ}_{θ}(zₜ, c; G_{θ}(g, zₜ, c)) instructs the system to set the student image generation model (e.g., the student image generation model described with reference to FIG. 14). Then,

$${L}_{θ} = {‖ {e}_{teacher} - e ‖}_{2}^{2}$$

instructs the system to calculate a distillation loss (e.g., the distillation loss described with reference to FIG. 14) based on the teacher model and the student model. Then, θ←θ−γ∇_{θ}L_{θ} instructs the system to update parameters of the student image generation model based on the distillation loss.

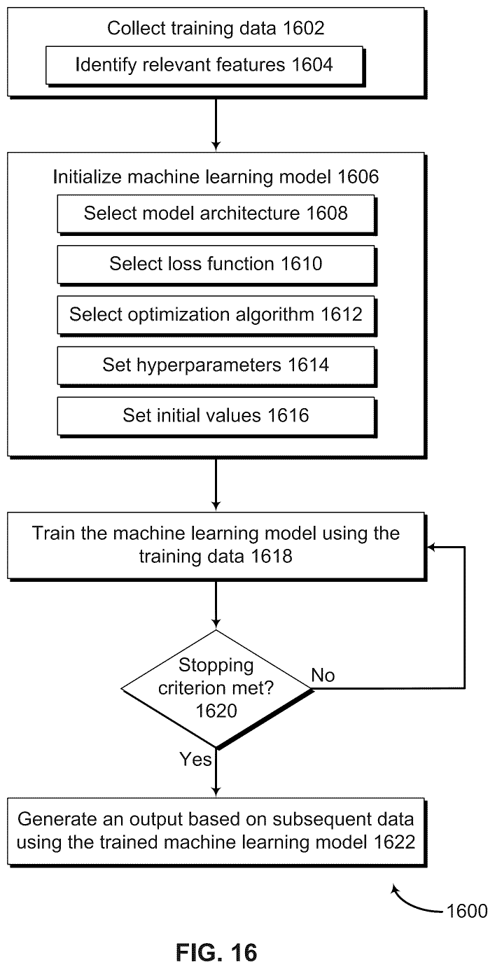

FIG. 16 shows an example of a flow diagram depicting an algorithm as a step-by-step procedure 1600 in an example implementation of operations performable for training a machine learning model according to aspects of the present disclosure. In some embodiments, the procedure 1600 describes an operation of the training component 635 described for configuring the image generation model 630 as described with reference to FIG. 6. The procedure 1600 provides one or more examples of generating training data, use of the training data to train a machine-learning model, and use of the trained machine-learning model to perform a task.

To begin in this example, a machine-learning system collects training data (block 1602) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1604) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1606). Initialization of the machine-learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1610). The loss function is utilized to measure a difference between an output of the machine-learning model (e.g., the model predictions) and target values (e.g., as expressed by the training data) to be used to train the machine-learning model. Additionally, an optimization algorithm is selected (block 1612) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1616) examples of which include initializing weights and biases of nodes to improve efficiency in training and computational resources consumption as part of training. Hyperparameters are also set (block 1614) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1618) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1620), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), procedure 1600 continues the training of the machine-learning model using the training data (block 1618) in this example.

If the stopping criterion is met (“yes” from decision block 1620), the trained machine-learning model is then utilized to generate an output based on subsequent data (block 1622). The trained machine-learning model, for instance, is trained to perform a task as described above and therefore once trained is configured to perform that task based on subsequent data received as an input and processed by the machine-learning model.

FIG. 17 shows an example of a method 1700 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1700 describes an operation of the training component 635 described for training the image generation model 630 as described with reference to FIG. 6. The method 1700 represents an example for training a reverse diffusion process as described above with reference to FIG. 12. In some examples, these operations are performed by a system including a processor executing a set of codes to control functional elements of an apparatus, such as the image generation model described in FIG. 6.

At operation 1705, the system initializes an untrained model. In some cases, the operations of this step refer to, or may be performed by, a training component as described with reference to FIG. 6. Initialization can include defining the architecture of the model and establishing initial values for the model parameters. In some cases, the initialization can include defining hyper-parameters such as the number of layers, the resolution and channels of each layer block, the location of skip connections, and the like.

At operation 1710, the system adds noise to media item using forward diffusion process in N stages. In some cases, the operations of this step refer to, or may be performed by, a training component as described with reference to FIG. 6. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1715, the system, at each stage n, starting with stage N, predicts media item for stage n-1. In some cases, the operations of this step refer to, or may be performed by, a training component as described with reference to FIG. 6. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1720, the system compares the predicted media item (or feature) at stage n-1 to media at stage n-1. In some cases, for example, the system compares the synthetic image (or predicted image feature) at state n-1 to the ground-truth image (or ground-truth feature) at state n-1. In some cases, the operations of this step refer to, or may be performed by, a training component as described with reference to FIG. 6. For example, given observed data x, the diffusion model may be trained to minimize the variational upper bound of the negative log-likelihood −log p_{θ}(x) of the training data.

At operation 1725, the system updates parameters of the model based on the comparison. In some cases, the operations of this step refer to, or may be performed by, a training component as described with reference to FIG. 6. For example, parameters of a U-Net may be updated using gradient descent. Time-dependent parameters of the Gaussian transitions can also be learned.

### Computing Device

FIG. 18 shows an example of a computing device 1800 according to aspects of the present disclosure. The example shown includes computing device 1800, processor 1805, memory subsystem 1810, communication interface 1815, I/O interface 1820, user interface component 1825, and channel 1830.

In some embodiments, computing device 1800 is an example of, or includes aspects of, the image processing apparatus described with reference to FIGS. 1 and 6. In some embodiments, computing device 1800 includes processor 1805 that can execute instructions stored in memory subsystem 1810 to obtain a text prompt and a guidance parameter, compute guidance features based on the text prompt and the guidance parameter, and generate a synthetic image that depicts the image element based on the text prompt and the guidance features.

According to some embodiments, processor 1805 includes one or more processors. In some cases, processor 1805 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1805 is configured to operate a memory array using a memory controller. In other cases, a memory controller is integrated into processor 1805. In some cases, processor 1805 is configured to execute computer-readable instructions stored in a memory to perform various functions. In some embodiments, processor 1805 includes special-purpose components for modem processing, baseband processing, digital signal processing, or transmission processing. Processor 1805 is an example of, or includes aspects of, the processor unit described with reference to FIG. 6.

According to some embodiments, memory subsystem 1810 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1810 is an example of, or includes aspects of, the memory unit described with reference to FIG. 6.

According to some embodiments, communication interface 1815 operates at a boundary between communicating entities (such as computing device 1800, one or more user devices, a cloud, and one or more databases) and channel 1830 and can record and process communications. In some cases, communication interface 1815 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1815.

According to some embodiments, I/O interface 1820 is controlled by an I/O controller to manage input and output signals for computing device 1800. In some cases, I/O interface 1820 manages peripherals not integrated into computing device 1800. In some cases, I/O interface 1820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1820 or hardware components controlled by the I/O controller. I/O interface 1820 is an example of, or includes aspects of, the I/O module described with reference to FIG. 6.

According to some embodiments, user interface component 1825 enables a user to interact with computing device 1800. In some cases, user interface component 1825 includes an audio device, such as an external speaker system, an external display device such as a display screen, an input device (e.g., a remote-control device interfaced with a user interface directly or through the I/O controller), or a combination thereof. User interface component 1825 is an example of, or includes aspects of, the user interface described with reference to FIG. 6.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIGS. 3 and 4.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text prompt and a guidance parameter, wherein the text prompt describes an image element and the guidance parameter indicates a level of guidance intensity for the text prompt;
computing, using a guidance model of an image generation model, guidance features based on the text prompt and the guidance parameter; and
generating, using the image generation model, a synthetic image that depicts the image element based on the text prompt and the guidance features.

2. The method of claim 1, further comprising:
encoding the text prompt to obtain a text embedding, wherein the guidance features and the synthetic image are based on the text embedding.

3. The method of claim 1, wherein generating the synthetic image comprises:
generating, using the image generation model, image features based on the text prompt; and
combining the guidance features and the image features to obtain combined features, wherein the synthetic image is generated the combined features.

4. The method of claim 1, wherein:
the guidance features comprise a plurality of layer-specific guidance feature maps corresponding to a plurality of decoding layers of the image generation model, respectively.

5. The method of claim 1, wherein generating the synthetic image comprises:
obtaining a noise map; and
denoising the noise map based on the text prompt and the guidance features to obtain the synthetic image.

6. The method of claim 5, wherein:
the guidance features are computed independently of the noise map.

7. The method of claim 1, wherein:
the guidance model is trained using a teacher model that includes a diffusion model of the image generation model.

8. A method of training a machine learning model, the method comprising:
obtaining a training set including a training prompt, a training image, and a guidance parameter, wherein the training prompt describes an image element, the training image depicts the image element, and the guidance parameter indicates a level of guidance intensity for the training prompt; and
training, using the training set, an image generation model to generate a synthetic image that depicts the image element based on the guidance parameter, the training comprising:
training a guidance model of the image generation model to computes guidance features based on the guidance parameter; and
training a diffusion model of the image generation model to generate the synthetic image based on the training prompt, the training image, and the guidance features.

9. The method of claim 8, further comprising:
obtaining a teacher model that includes the diffusion model of the image generation model, wherein the image generation model is trained as a student model of the teacher model.

10. The method of claim 9, further comprising:
generating, using the teacher model, a target output;
generating, using the image generation model, a predicted output;
computing a distillation loss based on the target output and the predicted output; and
updating parameters of the image generation model based on the distillation loss.

11. The method of claim 10, wherein generating the target output comprises:
generating a first preliminary output based on the training prompt;
generating a second preliminary output independent of the training prompt; and
combing the first preliminary output and the second preliminary output based on the guidance parameter to obtain the target output.

12. The method of claim 11, wherein:
the first preliminary output and the second preliminary output are independent of the guidance parameter.

13. The method of claim 8, wherein training the image generation model comprises:
updating parameters of the guidance model; and
freezing parameters of the diffusion model.

14. The method of claim 8, wherein training the image generation model comprises:
training the image generation model based on a first number of timesteps during a first training stage; and
training the image generation model based on a second number of timesteps during a second training stage.

15. An apparatus comprising:
at least one processor;
at least one memory storing instructions executable by the at least one processor; and
an image generation model comprising parameters stored in the at least one memory, wherein the image generation model is trained to generate a synthetic image that depicts an image element based on a text prompt, and wherein the image generation model comprises a guidance model trained to compute guidance features based on the text prompt and a guidance parameter that indicates a level of guidance intensity for the text prompt.

16. The apparatus of claim 15, wherein:
the image generation model comprises a diffusion model.

17. The apparatus of claim 16, wherein:
the guidance model has fewer parameters than the diffusion model.

18. The apparatus of claim 15, wherein:
the guidance model comprises a plurality of zero convolutional layers.

19. The apparatus of claim 15, wherein:
the guidance model takes the guidance parameter as an input.

20. The apparatus of claim 15, further comprising:
a text encoder configured to encode the text prompt to obtain a text embedding.
